(19) United States
(12) Patent Application Publication
(10) Pub. No.: US 2026/0285331 A1
(43) Pub. Date: Sep. 24, 2026

(54) SYSTEMS AND METHODS FOR AUTOMATIC SENSOR CONFIGURATION

(71) Applicant: Torc Robotics, Inc., Blacksburg, VA (US)

(72) Inventors: Karthik Kalidas, Albuquerque, NM (US); German Mene Santa Olaya, Bowie, MD (US); Hiroshi Suda, Pittsburgh, PA (US)

(21) Appl. No.: 19/084,224

(22) Filed: Mar. 19, 2025

(51) Int. Cl. B60W 50/02; B60W 50/00; G01C 21/16; G01S 13/931; G01S 17/931; G07C 5/00; H04L 41/22; H04L 67/12; H04N 17/00; H04W 4/44; H04W 4/48

(52) U.S. Cl. CPC B60W 50/0205; G01C 21/16; G01S 13/931; G01S 17/931; G07C 5/008; H04L 67/12; H04N 17/002; H04W 4/44; H04W 4/48; B60W 2050/0088; B60W 2050/0215; B60W 2420/403; B60W 2420/408; B60W 2556/45; H04L 41/22

(57) ABSTRACT

A system for automatic configuration of vehicle sensors can include a plurality of connectors to connect to a plurality of sensors of a vehicle. Each connector can be configured to provide a power connection and a data connection to a sensor of the plurality of sensors. The system can include a computing device including one or more hardware processors. The computing device can be configured to, identify each sensor, of the plurality of sensors, connected to a corresponding connector of the plurality of connectors, receive, via a user interface (UI), information indicative of a selected subset of sensors of the plurality of sensors to be configured, send a request for configuration settings of the subset of sensors to a remote computer system, receive, from the remote computer system, the configuration settings responsive to the request, and configure, using the configuration settings, the subset of sensors in a configuration session.

### TECHNICAL FIELD

The field of the disclosure relates to configuration of sensors and, in particular, to systems, devices and methods for configuring a plurality of sensors of a vehicle simultaneously or serially in a single configuration session.

### BACKGROUND

Modern vehicles, and in particular autonomous and semi-autonomous vehicles, include a variety of sensors to perceive their surroundings. The sensors are critical components especially for autonomous and semi-autonomous vehicles, because they act as the “eyes” and “ears” of the corresponding vehicles. In particular, the sensors provide via respective sensing techniques various perceptions of the surroundings or environment of the vehicle to enable various driver-assistance features and/or self-driving features. Sensors installed in a modern vehicle constantly monitor a multitude of parameters of the vehicle and its surrounding. Such parameters can include, e.g., engine temperature, oil pressure, tire pressure, vehicle speed, as well as the speed, distance, and relative position of objects around the vehicle. Sensor data collected by the vehicle sensors is typically fed or provided to one or more processing devices or units, such as the electronic control unit (ECU), which can be used to make real-time adjustments or decisions related to various systems of the vehicle.

With advancements in sensing technology and artificial intelligence, modern vehicles are equipped with a wide array of sensors to enable advanced driver-assistance systems (ADASs) and/or automated driving systems (ADSs). These systems rely mainly on sensor data provided by the sensors onboard the vehicle in decision making. As technology continues to evolve and vehicles become more automated, the role of sensors in modern vehicles becomes greater and more critical. In other words, the operation of modern vehicles, and automated vehicles in particular, depends on the reliability and accuracy of the sensors. For example, failure to accurately perceive the surroundings of an autonomous vehicle or failure to point the vehicle in the right direction could result in catastrophic accidents. Also, failure to detect defective or malfunctioning components in the vehicle can be costly.

Reliability and accuracy of onboard sensors calls for proper configuration and repeated calibration of the sensors. The sensor configuration step involves setting the proper parameters of the sensors during the production phase or when replacing a sensor on the vehicle. The sensor calibration step involves adjusting the sensors during the deployment phase of the vehicle to correct for any deviations in the sensor measurements. Deviations or offsets in sensor measurements can occur over time due to general sensor use or exposure of the sensor to various environmental factors.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an example system for automatic configuration of vehicle sensors can include a plurality of connectors to connect to a plurality of sensors of a vehicle. Each connector can be configured to provide a power connection and a data connection to a sensor of the plurality of sensors. The system can include a computing device including one or more hardware processors. The computing device can be configured to, identify each sensor, of the plurality of sensors, connected to a corresponding connector of the plurality of connectors, receive, via a user interface (UI), information indicative of a selected subset of sensors of the plurality of sensors to be configured, send a request for configuration settings of the subset of sensors to a remote computer system, receive, from the remote computer system, the configuration settings responsive to the request, and configure, using the configuration settings, the subset of sensors in a configuration session.

In some implementations, the system can include one or more automotive Ethernet switches connected to the plurality of connectors and configured to transform automotive Ethernet data to standard Ethernet data.

In some implementations, the plurality of connectors can be connectable to the plurality of sensors via one or more bulkhead interface devices.

In some implementations, the plurality of sensors can include a set of sensors mounted on a sensor bar structure.

In some implementations, the computing device can be configured to communicate with the plurality of sensors through an open systems interconnection (OSI) layer lower than an application layer.

In some implementations, the computing device can be configured to send, to each sensor of the plurality of sensors, a request for a serial number of the sensor, and receive, responsive to the request for the serial number, the serial number of the sensor.

In some implementations, the computing device can be configured to send to the UI information identifying the plurality of sensors connected to the plurality of connectors.

In some implementations, the plurality of sensors can include one or more light detection and ranging (LiDAR) sensors. The configuration settings for each LiDAR sensor can include at least one of firmware data, an internet protocol (IP) address for the LiDAR sensor, or one or more upload scan patterns.

In some implementations, the plurality of sensors can include one or more radio detection and ranging (radar) sensors. The configuration settings for each radar sensor can include at least one of firmware data, or an IP address for the radar sensor.

In some implementations, the plurality of sensors can include one or more cameras. The configuration settings for each camera can include visualization check data.

In some implementations, the plurality of sensors can include one or more inertial measurement units (IMUs). The configuration settings for each IMU can include functional check data.

In some implementations, the computing device can be configured to configure the plurality of sensors concurrently.

In some implementations, the computing device can be configured to send, to the remote computer system, information indicative of progress of the configuration of the subset of sensors. The information indicative of the progress of the configuration can be provided for display on the UI.

In some implementations, the computing device can be configured to receive, from a sensor of the subset of sensors, an indication of completed configuration of the sensor, acquire, from the sensor, recorded configuration settings at the sensor, compare the configuration settings recorded at the sensor to corresponding configuration settings received from the remote computer system, and send an indication of a result of the comparison to the remote computer system for display in the UI.

In some implementations, the computing device can include at least one of a wireless edge router configured to host a subscriber identity module (SIM) card for connecting to a wireless communications network, or an antenna to communicate with satellites.

In another aspect, an example method automatic configuration of vehicle sensors can include can include identifying each sensor of a plurality of sensors coupled to a vehicle sensor setup station device. The vehicle sensor setup station device can include a plurality of connectors each of which is configured to provide a power connection and a data connection to a sensor of the plurality of sensors, and a computing device including one or more hardware processors. The method can include receiving, via a user interface (UI), information indicative of a selected subset of sensors of the plurality of sensors to be configured, sending a request for configuration settings of the subset of sensors to a remote computer system, receiving, from the remote computer system, the configuration settings responsive to the request, and configuring, using the configuration settings, the subset of sensors in a single configuration session.

In some implementations, the vehicle sensor setup station device can include one or more automotive Ethernet switches connected to the plurality of connectors and configured to transform automotive Ethernet data to standard Ethernet data.

In some implementations, the plurality of connectors can be connectable to the plurality of sensors via one or more bulkhead interface devices.

In some implementations, the plurality of sensors can include a set of sensors mounted on a sensor bar structure.

In some implementations, the method can include communicating with the plurality of sensors through an open systems interconnection (OSI) layer lower than an application layer.

In some implementations, the method can include sending, to each sensor of the plurality of sensors, a request for a serial number of the sensor, and receiving, responsive to the request for the serial number, the serial number of the sensor.

In some implementations, the method can include sending to the UI information identifying the plurality of sensors connected to the plurality of connectors.

In some implementations, the plurality of sensors can include one or more light detection and ranging (LiDAR) sensors. The configuration settings for each LiDAR sensor can include at least one of firmware data, an internet protocol (IP) address for the LiDAR sensor, or one or more upload scan patterns.

In some implementations, the plurality of sensors can include one or more radio detection and ranging (radar) sensors. The configuration settings for each radar sensor can include at least one of firmware data, or an IP address for the radar sensor.

In some implementations, the plurality of sensors can include one or more cameras. the configuration settings for each camera can include visualization check data.

In some implementations, the plurality of sensors can include one or more inertial measurement units (IMUs). The configuration settings for each IMU can include functional check data.

In some implementations, the method can include configuring the plurality of sensors concurrently.

In some implementations, the method can include sending, to the remote computer system, information indicative of progress of the configuration of the subset of sensors. The information indicative of the progress of the configuration can be provided for display on the UI.

In some implementations, the method can include receiving, from a sensor of the subset of sensors, an indication of completed configuration of the sensor, acquiring, from the sensor, configuration settings of the sensor, comparing the configuration settings of the sensor to corresponding configuration settings obtained from the remote computer system, and sending an indication of a result of the comparison to remote computer system for display in the UI.

In some implementations, the vehicle sensor setup station device can include at least one of a wireless edge router configured to host a subscriber identity module (SIM) card for connecting to a wireless communications network, or an antenna to communicate with satellites.

In another aspect, an example system for automatic configuration of vehicle sensors is provided. The system can include one or more processors and a memory storing computer code instructions. The computer code instructions when executed by the one or more processors can cause the one or more processors to establish a connection with a vehicle sensor setup station device, receive, from the vehicle sensor setup station device, information identifying a plurality of sensors connected to the vehicle sensor setup station device, provide a user interface (UI) for managing configuration of the plurality of sensors at the vehicle sensor setup station device, receive, from the vehicle sensor setup station device, a request for configuration settings for a selected subset of sensors of the plurality of sensors, transmit, to the vehicle sensor setup station device, the configuration settings responsive to the received request, receive, from the vehicle sensor setup station device, information indicative of progress of a configuration session for configuring the subset of sensors at once, and provide the information indicative of the progress of the configuration session for display in the UI.

In some implementations, the UI can be configured to display, based on the information identifying the plurality of sensors, a list of visual items, each visual item representing a corresponding sensor of the plurality of sensors, enable selection of the subset of sensors, and enable triggering the configuration session at the vehicle sensor setup station device to configure the selected subset of sensors.

In some implementations, the information indicative of the progress of the configuration session can include validation information indicative of validation of configured settings for the subset of sensors, and the UI can include visual items representing the validation information for the subset of sensors.

In some implementations, the one or more processors can be configured to maintain a vehicle-lifecycle database for storing information about a lifecycle of the vehicle; update the vehicle-lifecycle database based on the information indicative of the progress of the configuration session or a configuration log file received from the vehicle sensor setup station device; and provide access, for one or more user devices, to the vehicle-lifecycle database.

In some implementations, to establish the connection with the vehicle sensor setup station device, the one or more processors can be configured to receive, from the vehicle sensor setup station device, a claim certificate identifying the vehicle sensor setup station device to the system, and in response, send a device certificate to the vehicle sensor setup station device. The device certificate can include a private key to secure communication between the vehicle sensor setup station device and the system.

In some implementations, the information identifying the plurality of sensors can include, for each sensor of the plurality of sensors, a respective serial number.

In some implementations, the plurality of sensors can include one or more light detection and ranging (LiDAR) sensors. The configuration settings for each LiDAR sensor can include at least one of firmware update data, an internet protocol (IP) address for the LiDAR sensor or one or more upload scan patterns.

In some implementations, the plurality of sensors can include one or more radio detection and ranging (radar) sensors. The configuration settings for each radar sensor can include at least one of firmware update data or an IP address for the radar sensor.

In some implementations, the plurality of sensors can include one or more cameras, and the configuration settings for each camera can include visualization check data.

In some implementations, the plurality of sensors can include one or more inertial measurement units (IMUs), and the configuration settings for each IMU can include functional check data.

In another aspect, an example method for automatic configuration of vehicle sensors can include establishing, by a cloud computer system, a connection with a vehicle sensor setup station device, receiving, by the cloud computer system from the vehicle sensor setup station device, information identifying a plurality of sensors connected to the vehicle sensor setup station device, providing, by the cloud computer system, a user interface (UI) for managing configuration of the plurality of sensors at the vehicle sensor setup station device, receiving, by the cloud computer system from the vehicle sensor setup station device, a request for configuration settings for a selected subset of sensors of the plurality of sensors, transmitting, by the cloud computer system to the vehicle sensor setup station device, the configuration settings responsive to the received request, receiving, by the cloud computer system from the vehicle sensor setup station device, information indicative of progress of a configuration session for configuring the subset of sensors at once, and providing, by the cloud computer system, the information indicative of the progress of the configuration session for display in the UI.

In some implementations, the UI can be configured to display, based on the information identifying the plurality of sensors, a list of visual items, each visual item representing a corresponding sensor of the plurality of sensors, enable selection of the subset of sensors, and enable triggering the configuration session at the vehicle sensor setup station device to configure the selected subset of sensors.

In some implementations, the information indicative of the progress of the configuration session can include validation information indicative of validation of configured settings for the subset of sensors, and the UI can include visual items representing the validation information for the subset of sensors.

In some implementations, the method can include maintaining a vehicle-lifecycle database for storing information about a lifecycle of the vehicle, updating the vehicle-lifecycle database based on the information indicative of the progress of the configuration session or a configuration log file received from the vehicle sensor setup station device, and providing access, for one or more user devices, to the vehicle-lifecycle database.

In some implementations, establishing the connection with the vehicle sensor setup station device can include receiving, from the vehicle sensor setup station device, a claim certificate identifying the vehicle sensor setup station device to the system, and in response, sending a device certificate to the vehicle sensor setup station device, the device certificate including a private key to secure communication between the vehicle sensor setup station device and the system.

In some implementations, the information identifying the plurality of sensors can include, for each sensor of the plurality of sensors, a respective serial number.

In some implementations, the, plurality of sensors can include one or more light detection and ranging (LiDAR) sensors. The configuration settings for each LiDAR sensor can include at least one of firmware update data, an internet protocol (IP) address for the LiDAR sensor or one or more upload scan patterns.

In some implementations, the plurality of sensors can include one or more radio detection and ranging (radar) sensors. The configuration settings for each radar sensor can include at least one of firmware update data or an IP address for the radar sensor.

In some implementations, the plurality of sensors can include one or more cameras, and the configuration settings for each camera can include visualization check data.

In some implementations, the plurality of sensors can include one or more inertial measurement units (IMUs), and the configuration settings for each IMU can include functional check data.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of an autonomous truck and trailer.

FIG. 4 is a block diagram of the autonomous truck shown in FIGS. 1-3.

FIG. 5 is a block diagram of an example computing system.

FIG. 6 is a block diagram of a sensor configuration platform, according to an example embodiment of the current disclosure.

FIG. 7A is an example implementation of a sensor configuration assembly, according to an example embodiment of the current disclosure.

FIG. 7B is a diagrammatic view of an example implementation of a sensor configuration assembly, according to an example embodiment of the current disclosure.

FIGS. 8A and 8B are a front view (FIG. 8A) and a back view (FIG. 8B) of a vehicle sensor setup station (VS3) device, according to an example embodiment of the current disclosure.

FIG. 9 is a diagram depicting an arrangement of wire harness connectors of the VS3 device and sensors connected thereto, according to an example embodiment of the current disclosure.

FIG. 10 is an example implementation of a network subsystem of the VS3 device, according to an example embodiment of the current disclosure.

FIG. 11A-11C are a top view (FIG. 11A), a front view (FIG. 11B), and a rear view (FIG. 11C) of a computing device of the VS3 device, according to an example embodiment of the current disclosure.

FIG. 12 is a flowchart of a method for sensor configuration, according to an example embodiment of the current disclosure.

FIG. 13 is a flowchart of a method for automatic configuration of vehicle sensors, according to an example embodiment of the current disclosure.

FIG. 14 is a block diagram depicting a software architecture for automatic sensor configuration, according to an example embodiment of the current disclosure.

FIG. 15 is a block diagram depicting a high-level software architecture for sensor configuration, according to an example embodiment of the current disclosure.

FIG. 16. is a block diagram depicting a high-level software architecture for cloud-based sensor configuration, according to an example embodiment of the current disclosure.

FIG. 17 is a signaling diagram depicting communications between the VS3 device and a remote computer system, according to an example embodiment of the current disclosure.

FIG. 18 is a flowchart illustrating a method for cloud-based automatic configuration of vehicle sensors, according to an example embodiment of the current disclosure.

FIG. 19A-19J are screenshots of various instances of a UI 1900 for configuring sensors, according to an example embodiment of the current disclosure, including selection screen for sensors connected to a VS3 device (FIG. 19A), an update confirmation screen (FIG. 19B), a configuration progress status screen (FIG. 19C), a validation progress for configured sensors screen (FIG. 19D), a screen depicting a comparison between expected and current configuration settings (FIG. 19E), a validation error or mismatch screen for expected and current configuration settings for a selected sensor (FIG. 19F), a sensor configuration error screen (FIG. 19G), a selection screen for cameras connected to the VS3 device (FIG. 19H), images generated by selected cameras (FIG. 19I), and a detailed view of an image generated by a selected sensor (FIG. 19J).

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

As modern vehicles become more automated, the reliability and accuracy of vehicle sensors becomes increasingly important. Vehicle sensors are not mere plug-and-play devices. To operate properly, many vehicle sensors require proper configuration when installed in a vehicle. Sensor configuration involves setting specific sensor parameters and/or calibrating certain functional aspects of the sensors. This sensor configuration process is typically performed during the production or commissioning process of the vehicle, although sensor configuration can also be performed when replacing sensors. In autonomous and semi-autonomous vehicles, sensor configuration is a prerequisite for the reliable functioning of various safety features, driver-assistance systems, self-driving systems, and/or engine management systems.

The current state of configuring vehicle sensors has multiple drawbacks. First, the sensors are typically configured manually one at a time. For each sensor to be configured, a technician usually connects the sensor to a user device via a corresponding adapter or manual interface. The adapter or manual interface enables powering on and communication with the sensor. Second, the sensor configuration is performed using a proprietary configuration software that is executed by the user device connected to the sensor. The manual interface and the proprietary configuration software are provided by the manufacturer of the sensor, and they are usually specific to the type and make of the sensor. Third, for each sensor type and make, the proprietary configuration software can have separate compatibility requirements in relation with the user device. For example, the proprietary configuration software for a given sensor type and make can be operable with user devices having a specific operating system (OS), certain memory capacity and/or a specific connector type to connect to the manual interface. The compatibility requirements can also change with the version of the proprietary configuration software. Finally, current configuration procedures are prone to error and do not provide an easy way to validate performed sensor configuration.

The above discussed drawbacks make the sensor configuration process more complex and time consuming. In particular, the technician has to configure the sensors of a vehicle one at a time. For each sensor, the technician downloads the proper configuration software on the user device, connects the sensor to the user device via a corresponding manual interface, and then executes the configuration process. These steps are repeated for each separate sensor of the vehicle, where different manual interfaces and different configuration software tools are used for distinct sensors. Once a sensor is configured, validation of the configuration calls for additional steps to be performed by the technician. Reliable and efficient configuration of the vehicle sensors therefore necessitates that the technician be knowledgeable and familiar with the various proprietary software tools and manual interfaces for different sensors.

The number of sensors in modern vehicles is relatively large, e.g., compared to older vehicles. The relatively large number of sensors makes the configuration process even more time consuming, which calls for an automated, efficient and simpler sensor configuration process. As the sensors become more crucial to safety features and basic operations of modern vehicles, the reliability and accuracy of the sensor configuration becomes even more important, which calls for processes to validate sensor configurations.

Accordingly, there exists a need for a system and a method of sensor configuration that can be performed automatically for multiple sensors in a single configuration session, e.g., simultaneously or in series responsive to a request or instruction from a user interface. These and other needs are met by the systems and methods for sensor configuration discussed herein.

Embodiments illustrated herein describe a sensor configuration platform that automates the configuration of sensors, e.g., configuration of sensor parameters and firmware. The sensor configuration platform enables configuring all sensors (or any subset thereof) of the vehicle in a single configuration session or all at once. The sensor configuration platform enables remote sensor configuration and automated validation of the performed sensor configurations. In particular, a plurality of sensors of the vehicle can be simultaneously connected to the sensor configuration platform and can be configured in parallel or in series in a single and relatively short configuration session. The sensor configuration platform can validate the configuration of each session and displays the validation results to a user, providing a clear indication of successful completion of the configuration process or any errors encountered during the configuration process.

The sensor validation platform can include a compact assembly or an edge device for simultaneously connecting to and configuring all, or a plurality of, vehicle sensors. The edge device is referred to herein as a vehicle sensor setup station (VS3) or VS3 device. The VS3 device enables powering on and communication with all the vehicle sensors connected thereto. The VS3 device can configure a plurality of sensors at once or in a single configuration session. The VS3 device can be managed through a user interface running on a user device, where a user can trigger the configuration of sensors connected to the VS3 device via one or more interactions with the UI.

The systems and methods described herein increase the efficiency and accuracy of incoming inspection and configuration (I&C) processes by reducing the number of steps needed to complete this stage of the commissioning process. Furthermore, the sensor configuration process is made much faster and automated. In particular, the VS3 device communicates with the sensors connected thereto at one or more layers of the open systems interconnection (OSI) model lower than the application layer. As such, the VS3 device makes the configuration processes independent of proprietary configuration tools provided by sensor manufacturers. As a result, instead of using various hardware and software tools with different requirements to configure different types of sensors, the VS3 device enables configuration of various types of sensors with little input from a user. The VS3 device frees up engineering personnel by homogenizing the configuration process. With the VS3 device, engineers no longer need to make the unique configuration changes required of each individual sensor. Rather, a technician can now connect one or all of the sensors from the VS3 device to the sensors and interact with one or few interactive items in a UI to configure the sensors connected to the VS3 device at once. As such, the sensor configuration can be performed by a technician and frees up engineers to troubleshoot other potential issues.

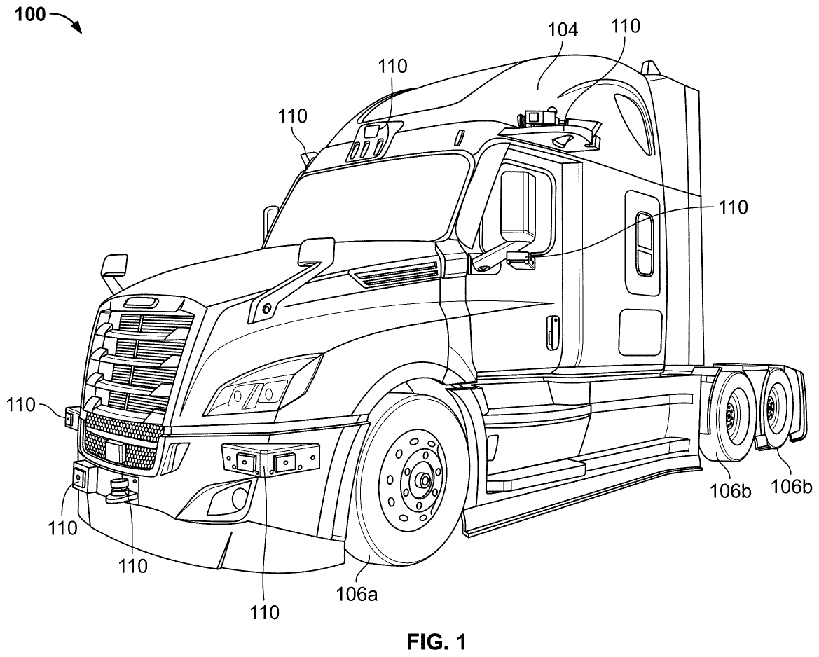

Various embodiments in the present disclosure are described with reference to FIGS. 1-19J below.

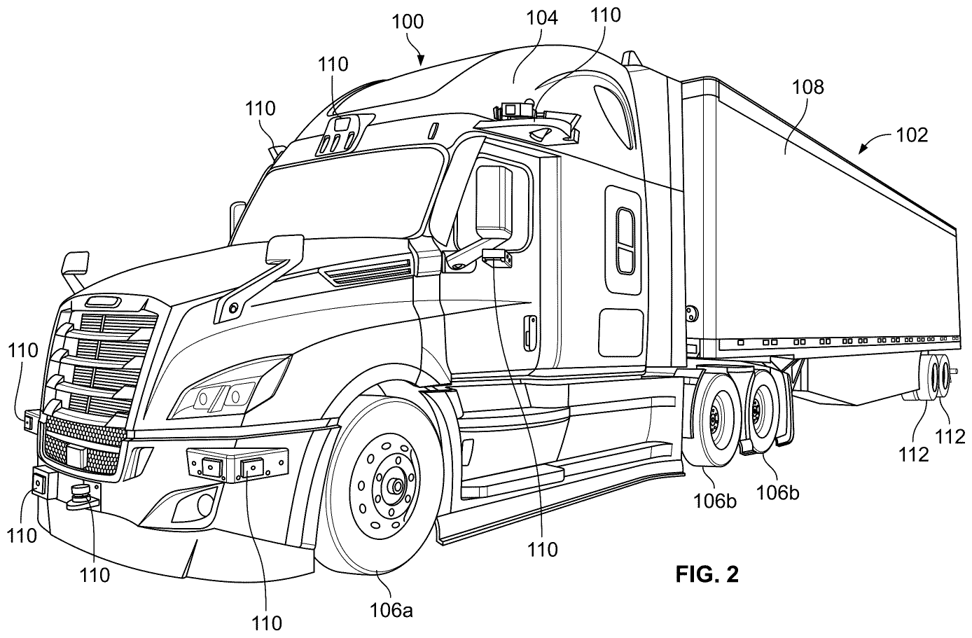

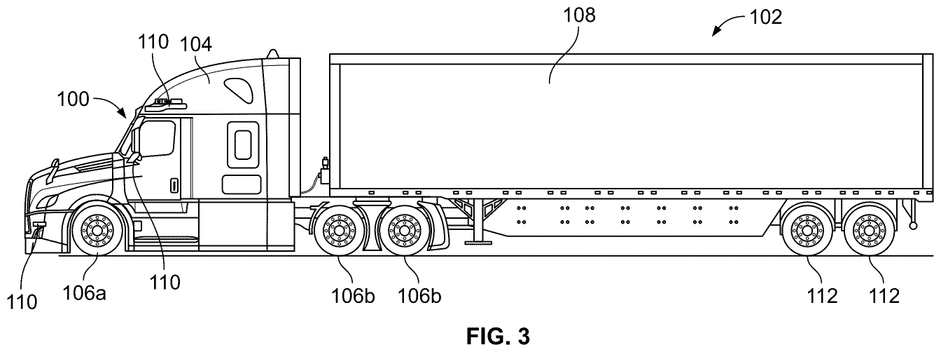

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

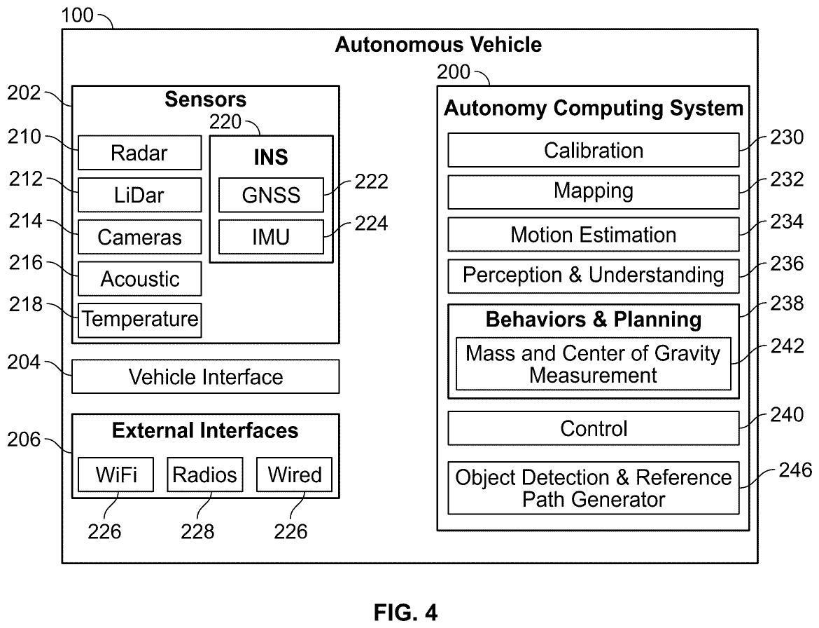

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

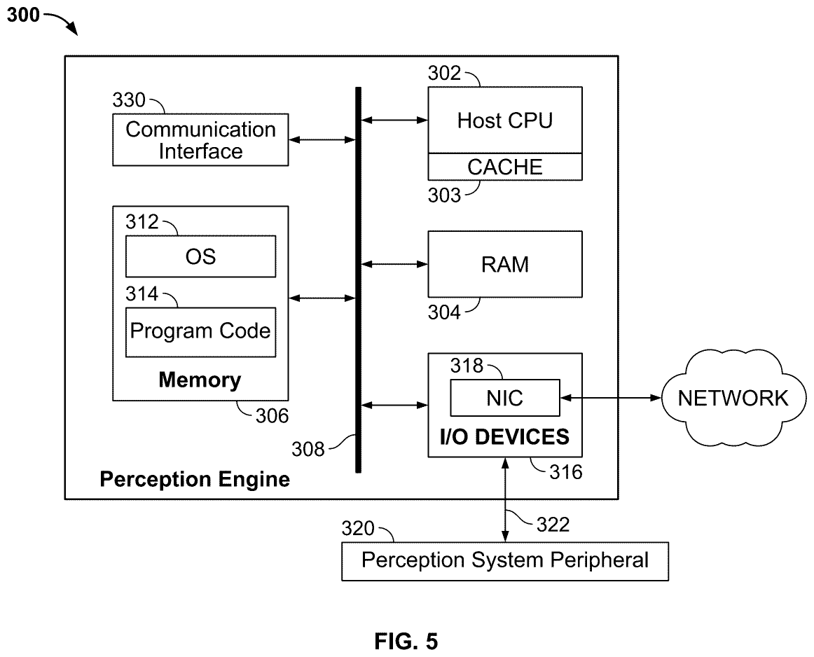

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

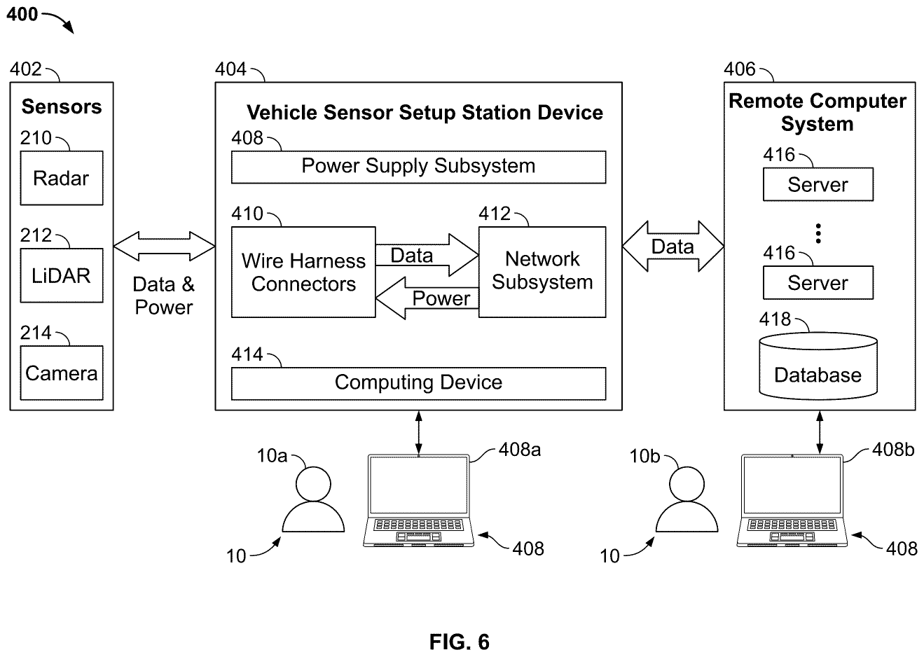

FIG. 6 is a block diagram of a sensor configuration platform 400, according to an example embodiment of the current disclosure. In brief overview, the sensor configuration platform 400 can include a plurality of sensors 402 of the vehicle 100 to be configured, a vehicle sensor setup station (VS3) device 404 and a remote system 406. The sensors 402 to be configured can include all of the sensors 202 of the vehicle 100 or a subset thereof. For instance, the sensors 402 can include the radar sensor(s) 210, the LiDAR sensor(s) 212 and/or the camera(s) 214, among other sensors of the vehicle 100. The remote system 406 can be or can include a cloud system and/or an Internet-of-things (IoT) core system.

The VS3 device 404 can be an edge computing device connected or configured to be connected to the sensors 402. The VS3 device 404 can include a power supply subsystem 408, wire harness 410 connectors, a network subsystem 412 and a computing device 414. The power supply subsystem 408 can be connected to a power outlet and provides power to various components of the VS3 device 404, as well as to the sensors 402. The power supply subsystem 408 can include one or more AC-to-DC converters and one or more circuit breakers. The wire harness connectors 410 can include various types of connectors at the VS3 device 404 to receive wires or wire connectors associated with various sensors 402.

The network subsystem 412 can include a plurality of connectors for connecting the sensors 402 to the VS3 device 404, a power controller for distributing power to the sensors 402 and other components of the VS3 device 404. Network subsystem 412 can include one or more switches for routing data connections between the sensors 402 and the computing device 414. The network subsystem 412 can provide a power connection and data connection for each sensor 402 connected to the VS3 device 404. In other words, the VS3 device 404 can provide or enable, for each sensor 402, a corresponding power connection and a corresponding data connection. The network subsystem 412 can connect the computing device 414 to the various wire harness connectors 410 or sensors 402 connected thereto.

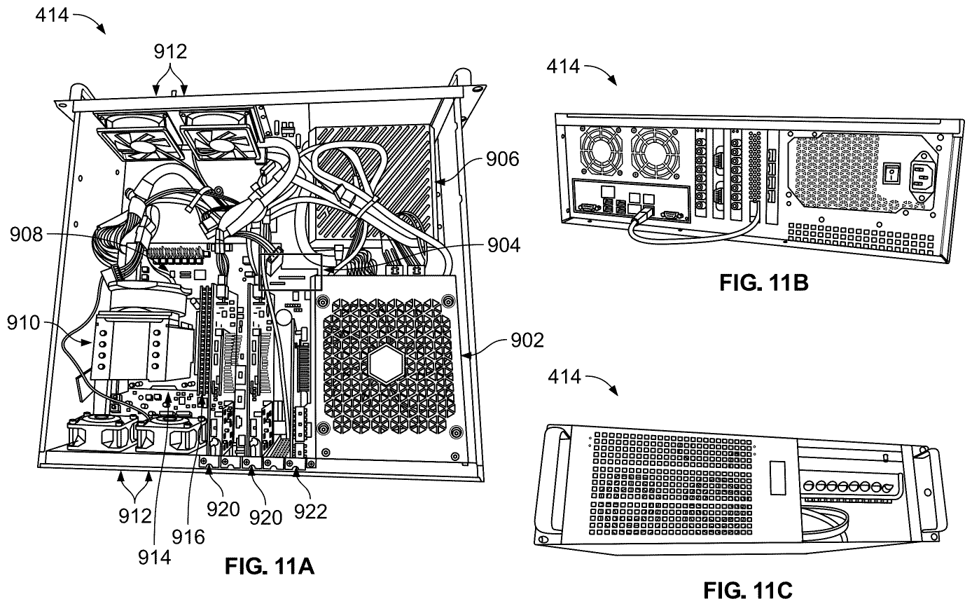

The computing device 414 can manage and execute the configuration of the sensors 402. The computing device 414 can manage communications with the sensors and the remote system 406. The computing device 414 can acquire configuration settings for various sensors 402 from the remote system 406 and configure each sensor 402 according to the corresponding configuration settings. The computing device 414 is described in further detail below in relation to FIG. 11A-11C.

The remote system 406 can be, or can reside in, a cloud system. The remote system 406 can be or can include an Internet-of-things (IoT) core system. The remote system 406 can be communicatively coupled to a plurality of VS3 devices 404. For example, the remote system 406 can communicate with and serve VS3 devices 404 at different locations. The remote system 406 can provide sensor configuration settings to the VS3 devices 404 and keep track of the configuration status of each sensor 402. The remote system 406 can include or host cloud applications, e.g., IoT applications, related to sensor configuration, vehicle commissioning and/or vehicle lifecycle managing or monitoring. The remote system 406 can include one or more computer servers 416 and one or more databases 418. Each computer server 416 can include one or more respective processors, (e.g., similar to CPU 302) one or more cache memories, (e.g., similar to cache 303) a random access memory, (e.g., similar to RAM 304) a memory (e.g., similar to memory 306) storing computer code instructions, and a communication interface (e.g., similar to communication interface 330). The computer code instructions, when executed, can cause the one or more processors to perform methods or operations described herein. The database(s) 418 can store desired configuration settings for various types of sensors 402 and/or information indicative of the configuration status for each sensor 402. The database(s) 418 can store computer programs of the VS3 device(s) 404 and/or updates thereof. The remote system 406 can provide software updates to the VS3 device(s) 404.

The sensor configuration platform 400 can be implemented as an IoT platform that enables automated and/or remote configuration of sensors 402. The remote system 406 can enable users to configure sensors 402 remotely. The remote system 406 can provide a user interface (UI) for users to initiate, manage and monitor configurations of sensors 402 for a plurality of vehicles 100. The platform 400 can be or can include an IoT platform for commissioning a plurality of vehicles 100 or a fleet of vehicles 100 owned by a single entity. The remote system 406 can provide a vehicle commissioning portal or cloud application for commissioning vehicles 100 or a fleet of vehicles 100. The automation of the sensor configuration as described herein makes the commissioning process much faster and more reliable. Also, the use of IoT platform helps streamline the commissioning process.

The VS3 device 404 can act as an IoT edge device with most of the sensor configuration processing performed by the VS3 device 404. By employing an IoT edge computing architecture, most of the processing associated with sensor configuration is executed or performed close to the sensors 402 to be configured, instead of a centralized processing at the cloud or remote system 406. Besides the edge computing architecture of the sensor configuration platform 400, which reduces communications between the remote system 406 and the VS3 device 404, the VS3 device(s) 404 enables configuration of a plurality of sensors 402 in a single session or at once, e.g., simultaneously or serially responsive to a request or instruction from user device 408.

Users 10 can manage the sensor configuration process for a set of sensors 402 of a vehicle 100 via user devices 408. A local user 10a can use a local user device 408a to connect to the VS3 device via a UI to manage and/or monitor the sensor configuration process. A remote user 10b can use a remote user device 408b to connect to the remote system 406 via the UI. The UI can be a web UI provided by or associated with the remote system 406. The remote user 10b can remotely manage and/or monitor, via the user device 408b and the UI, the configuration process. The user 10, either remote or local, can also access information indicative of sensor configuration statuses for separate vehicles 100, e.g., as part of the commissioning process.

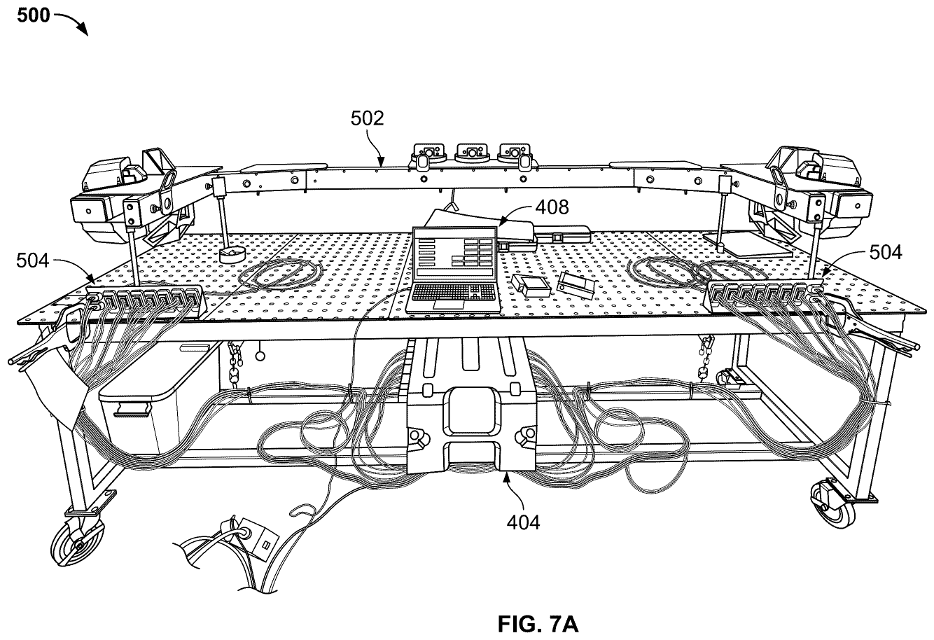

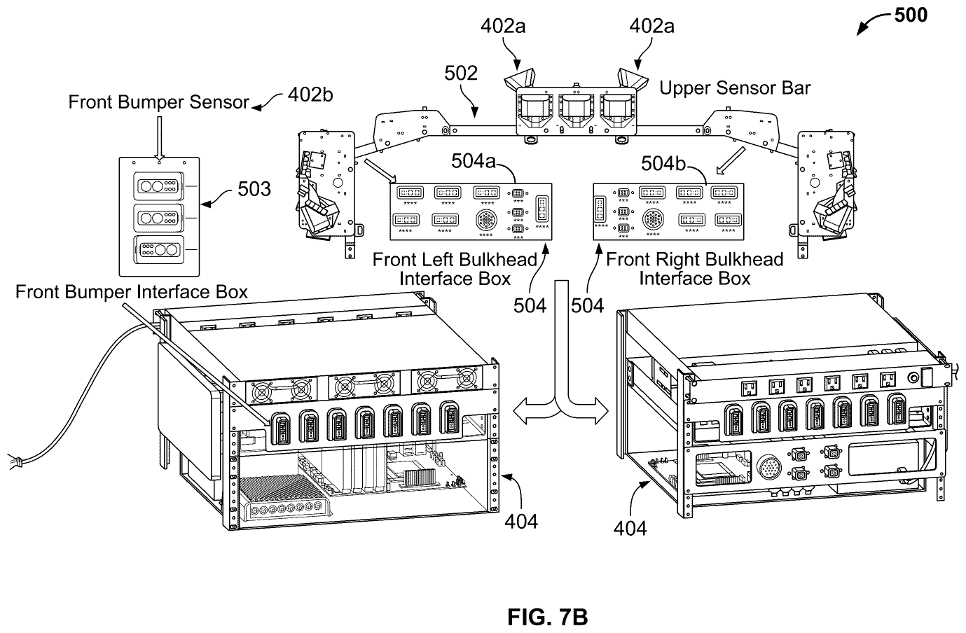

FIG. 7A depicts an implementation of a sensor configuration assembly 500, according to an example embodiment of the current disclosure. FIG. 7B is another depiction of the sensor configuration assembly 500, according to an example embodiment of the current disclosure. The sensor configuration assembly 500 can include the VS3 device 404 and a sensor board 502 on which at least a subset of sensors 402a can be mounted. The sensor board 502 can include, for each sensor type, one or more specific mounting positions. For example, the sensor board 502 can include one or more mounting positions designated for radar sensor(s) 210, one or more mounting positions for LiDAR sensor(s) 212, one or more mounting positions designated for camera(s) 214, and/or one or more mounting positions designated for IMU(s) 224.

The sensor board 502 can include or can be associated with one or more bulkhead interface boxes 504. For example, the sensor configuration assembly 500 can include a left bulkhead interface box 504a and a right interface box 504b. Some of the sensors 402a mounted on the sensor board 502 can be connected to the left bulkhead interface box 504a while the rest of the sensors 402a mounted on the sensor board 502 can be connected to the right bulkhead interface box 504b. The sensors 402 can include one or more sensors 402b that are not mounted, or not mountable, on the sensor board 502. The sensors 402b can be connected to another interface 503, e.g., via one or more custom post wire harnesses. The one or more bulkhead interface boxes 504 and the interface 503 can be connected to the VS3 device 404 via one or more other wire harnesses. For example, the left bulkhead interface box 504a can be connected wire harness connectors 410 on one side, e.g., rear side, of the VS3 device 404, while the right bulkhead interface box 504a can be connected to wire harness connectors 410 on another side, e.g., front side, of the VS3 device 404.

A local user device 408 (e.g., a computing or processing device) can be communicatively coupled to the VS3 device 404 to manage the configuration of the sensors 402. While the user device 408 is shown in FIG. 7A as a laptop, in general, the user device 408 can be a desktop, a laptop, a smart phone, a handheld device, a wireless device or any other device capable of connecting to the Internet. In some implementations, and as described in further detail below, the local user device 408 can connect to the Internet via the VS3 device 404.

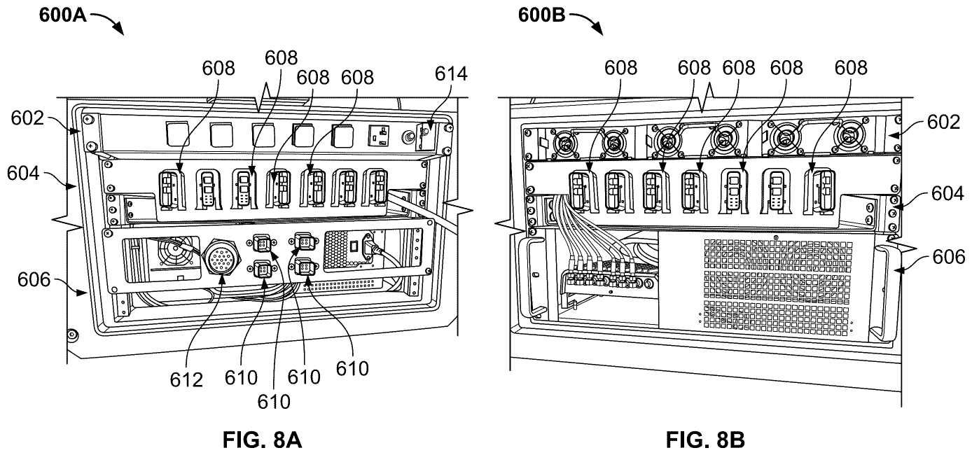

FIGS. 8A and 8B depict images of a front side 600A and a rear side 600B of the vehicle sensor setup station (VS3) device 404, according to an example embodiment of the current disclosure. The VS3 device 404 can include a power shelf 602 hosting the power subsystem 408, a network shelf 604 hosting some of the wire harness connectors 410 and the network subsystem 412, and a compute shelf 606 hosting the computing device 414 and some other wire harness connectors 410. The VS3 device 404 can include a plurality of connectors, e.g., TE (Technica Engineering) 2+6 connectors, 608 configured to receive corresponding cables for connecting to radar sensors 210 and LiDAR sensors 212. For example, the VS3 device 404 can include seven TE 2+6 connectors 608 arranged in the front side 600A and another seven TE 2+6 connectors 608 arranged in the rear side 600B. The TE 2+6 connectors 608 can be arranged along the network shelf 604. Each TE 2+6 connector 608 can connect a pair of sensors, e.g., a pair of radar sensors 210 or a pair of LiDAR sensors 212. In some implementations, the connectors 608 can include other types of connectors, e.g., other than of TE 2+6 connectors.

The VS3 device 404 can include a plurality of 4-pin FAKRA connectors 610 for connecting the cameras 214 to the device 404. Each 4-pin FAKRA connector 610 can connect four separate cameras 214. The VS3 device 404 can include four 4-pin FAKRA connectors 610 capable of connecting 16 cameras. In some implementations, the connectors 610 can include other types of connectors, e.g., other than 4-pin FAKRA connectors. The VS3 device 404 can include a 19-pin Deutsche connector 612 or another type of connector capable of connecting the IMUs 224. The 4-pin FAKRA connectors 610 and the 19-pin Deutsche connector 612 can be arranged in the front side 600A along the compute shelf 606. The front side 600A can include a power button 614 for powering on the VS3 device 404. The arrangement of the

FIGS. 8A and 8B depict an illustrative example of the types and arrangement of the wire harness connectors 410 integrated in the VS3 device 404. The types and number of connectors 410 depend on the types and number of sensors 402 supported by the VS3 device 404. For example, the VS3 device 404 can include other types of connectors 410 and/or the numbers of various types of connectors can be different than the example shown in FIGS. 8A and 8B, depending on the sensor and/or vehicle configuration being used with the VS3 device 404.

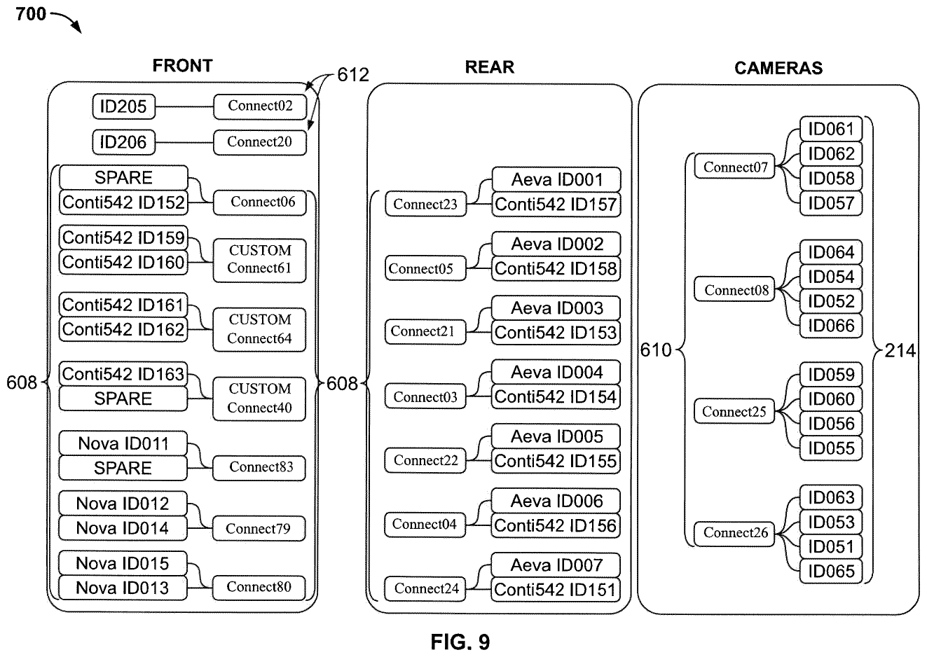

FIG. 9 is a diagram depicting an arrangement 700 of wire harness connectors 410 and sensors connected thereto, according to an example embodiment of the current disclosure. The various connectors 410 of the VS3 device 404 can be distinctly labeled to facilitate connecting each sensor to the corresponding connector 410. The wire harness connectors 410 can include two Deutsche connectors 612 for connecting IMUs 224, 14 TE and/or other types of connectors for connecting radar sensors 210 and LiDAR sensors 212, and four FAKRA connectors 610 for connecting a plurality of cameras 214.

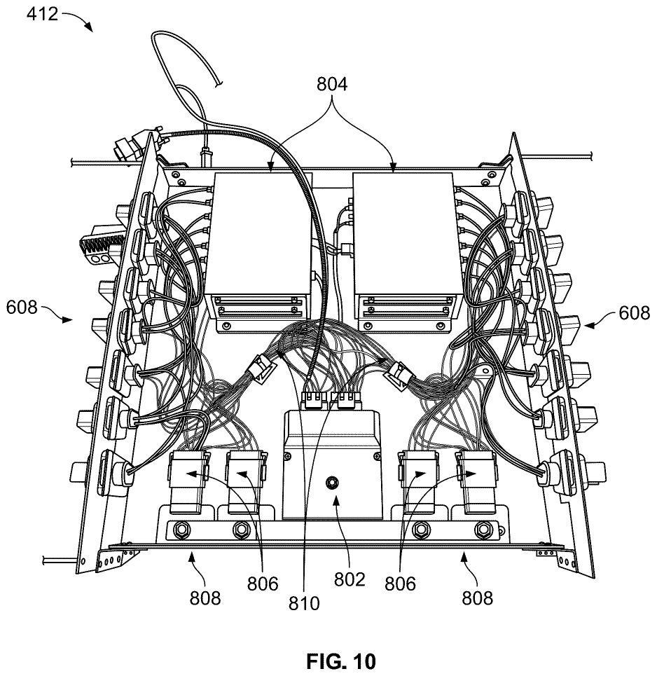

Referring now to FIG. 10, an image of an example implementation of the network subsystem 412 is shown, according to an example embodiment of the current disclosure. In brief overview, the network subsystem 412 can include a power distribution device (or module) 802, one or more Ethernet switches 804, and one or more ground connectors 806 for connecting various components to a ground 608. The power distribution device 802 can be configured or structured to distribute power to the various sensors 402 via the wire harness connectors 410. For example, the power distribution device 802 can distribute or channel power, e.g., DC power, from the power subsystem 408 to the radar sensors 210 and the LiDAR sensors 212 via the TE connectors 608, to the cameras 214 via the FAKRA connectors 610 and/or to the IMUs 224 via the Deutsche connectors 612. Power cables 810 can connect the connectors 410 to the power distribution device 802. For a sensor 402, a separate power cable 810 can connect the power distribution device 802 to the corresponding connector 410. When a sensor 402 is connected to the corresponding connector 410, the sensor 402 can be powered by the VS3 device 404. For example, the radar sensors 210 and the LiDAR sensors 212 can be powered via the TE 2+6 connectors 608, the cameras 214 can be powered via the FAKRA connectors 610, and the IMUs 224 can be powered via the Deutsche connectors 612. In some implementations, the power distribution device 802 can be a MoTeC power distribution module.

The network subsystem 412 can include one or more Ethernet switches 804 configured to manage and direct data flow between the sensors 402 and the computing device 404. For example, the network subsystem 412 can include four Ethernet switches 804 connecting the connectors 410 or the sensors 402 connected thereto to the computing device 414. The Ethernet switch(es) 804 can be configured to convert automotive Ethernet data to standard Ethernet data. Automotive Ethernet and standard Ethernet follow different standards. The automotive Ethernet typically uses the 100Base-T1 standard, while the standard Ethernet uses various standards (e.g., 100Base-TX, or the like) depending on the data speed. Standard Ethernet can be used when communicating with the remote system 406. For a sensor 402, a separate data cable, e.g., a twisted pair cable, can connect the corresponding connector 410 to an Ethernet switch 804. For a connector 410 that is configured to connect to multiple sensors 402, the connector 410 can be connected to the Ethernet switches 804 via multiple data cables, with a separate cable for each sensor 402.

The network subsystem 412 can include one or more ground connectors 806 for connecting the connectors 402, the power distribution device 802 and/or other components of the VS3 device 404 to the ground 808. The ground 808 can be implemented as one or more copper bars or plates. For each sensor 402, a separate cable can connect the connector 402 (with which the sensor 402 is engaged) to one of the ground connectors 806. As such, a sensor 402 can be associated with a power cable 810, a data cable and a ground cable.

When the VS3 device 404 is powered on, the power distribution device 802 also powers on and causes each of the sensors 402 connected to connectors 410 to be powered on. The device 404 therefore can simultaneously or substantially simultaneously power on each of the sensors 402 connected to the device 404. The computing device 414 can detect sensors 402 connected to the VS3 device 404 and identify the connected sensors 402.

FIGS. 11A-11C depict various views of the computing device 414, according to an example embodiment of the current disclosure. FIG. 11A is an image of an interior view of the computing device 414. FIG. 11B is an image of a front view of the computing device 414, and FIG. 11C is an image of a rear view of the computing device 414. In brief overview, the computing device 414 can include a motherboard power supply 902, a non-volatile memory 904, a wireless edge router 906, a motherboard 908, a cooler 910, a processor or CPU 912, one or more fans 914, a random access memory (RAM) 916, a controller area network (CAN) card 918, one or more video capture cards 920, and a network card 922. The computing device 414 con be configured to manage the sensor configuration process as described in further detail below.

The non-volatile memory 904 and/or the RAM 916 can store computer code instructions which, when executed by the processor 912, cause the computing device 414 to perform the sensor configuration process and/or related methods described herein. The computing device 414 can manage a sensor configuration session from start to end. A configuration session can start with the detection and/or identification of sensors 402 connected to the VS3 device 404 and can include configuring all the sensors 402 or a selected subset thereof at once. The computing device 414 can manage communications with the sensors 402 and/or the remote system 406.

The motherboard power supply 902 can supply power to the power board 908 as well as other components of the VS3 device 404. The non-volatile memory 904 and/or the RAM 916 can store data received from the remote system 406 and/or data acquired from the sensors 402. The cooler 910 and/or the fan(s) can cool components of the VS3 device 404, such as the non-volatile memory 904, the wireless edge router 906, the motherboard 908, the processor 912, the RAM 916, the CAN card 918, the video capture card(s) 920 and/or the network card 922.

The wireless edge router 906 can provide wireless connection to user devices 408 in the vicinity of the VS3 device 404. In some implementations, the wireless edge router 906 can be or can include a CRADLEPOINT® router. In some implementations, the wireless edge router 906 can include or host a subscriber identity module (SIM) card for connecting to a wireless communications network. The wireless edge router 906 can provide Wi-Fi connections to nearby user devices 408. In some implementations, the VS3 device 404 can include an antenna to communicate with or receive data from satellites. The antenna can be arranged outside a housing of the VS3 device 404.

The CAN card 918 can facilitate communication between various component of the VS3 device 404 and/or coordinating functions of the sensors 402 connected to the VS3 device 404. The CAN card 918 can handle CAN protocol data and can include a channel or connection for power statistics data coming from the power distribution module 802 and another channel for IMU data coming from the IMUs 224. The power statistics data coming from the power distribution module 802 can include information such as sensor current draw, sensor voltage and/or other sensor power information.

The video capture card(s) 920 can facilitate or enable capturing video and/or image data from the multiple cameras 214. The video capture card(s) 920 can decode image or video data received from the cameras 214. The video capture card(s) 920 can enable synchronization of camera streams from the cameras 214, and time stamping and real-time image processing of image data captured by the cameras 214. The video capture card(s) 920 can enable modular frame grabbing. In some implementations, the video capture card(s) 920 can be a SOLECTRIX® card(s). The network card 922 can enable or facilitate communication with the remote system 406 and/or user devices 408. The VS3 device 404 can communicate with the remote system 406 via a communication network. The communication network can include a local area network (LAN), a metropolitan area network (MAN), a wide area network (WAN), a cellular network or a combination thereof. A local user device 408a can communicate with the VS3 device 404 via Wi-Fi provided by the wireless edge router 906.

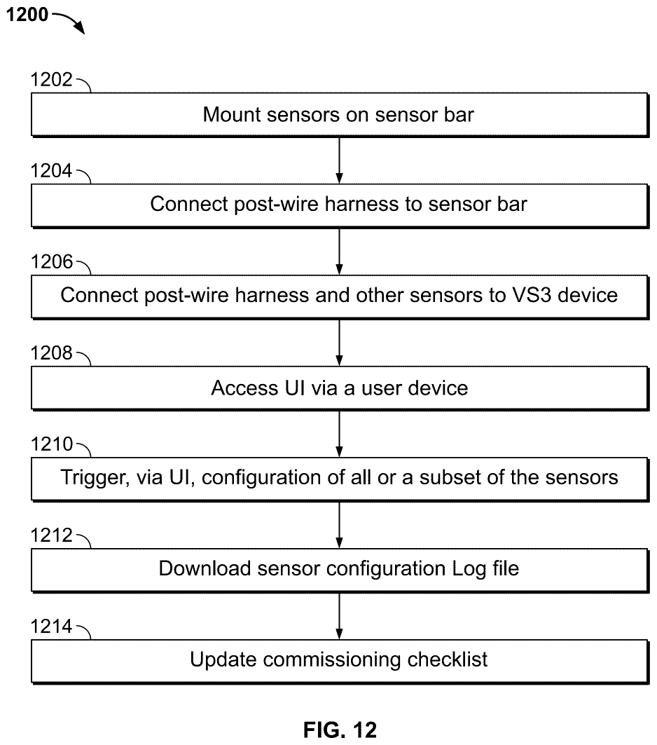

Referring now to FIG. 12, a flowchart of a method 1200 for sensor configuration is shown, according to an example embodiment of the current disclosure. The method 1200 can be performed by one or more users of the VS3 device 404 or the sensor configuration platform 400. The method 1200 can be performed by a local user 10a or by local and remote users 10. A local user 10a can mount multiple sensors 402 on a sensor board 502. The user 10a can mount a subset of the sensors 402 to be configured on the sensor board 502 (1202). The sensor board 502 can be an upper sensor board of a truck 100. Some sensors 402 may not be mounted on the sensor board 502.

The local user 10a can connect a post-wire harness to the sensor bar 501 (1204), and connect the post-wire harness to the VS3 device 404 (1206). The post wire harness is the wire harness connecting the sensors 402 to the bulkhead interface boxes 504 and the prewire harness is the wire harness connecting the bulkhead interface boxes 504 and VS3 device 404. The local user 10a can connect, via the post-wire harness, the sensor bar 502 to the VS3 device 404 after powering on the VS3 device 404. The local user 10a can also connect other sensors 402 (not mounted on the sensor bar 502), via an associated post-wire harness, to the VS3 device 404 (1206). The method 1200 can include the local user 10a accessing, via a local user device 408a, a UI of the sensor configuration platform 400 to manage configuration of the sensors 402 (1208). The UI can be a web user interface accessible via an Internet protocol (IP) address of the VS3 device 404. The web user interface can be hosted by the VS3 device 404 or the remote system 406. In some implementations, once the VS3 device 404 is connected to the sensors 402, a remote user 10b can access the UI via a remote user device 408b. The remote user device 408b can access the UI via the remote system 406 as depicted in FIG. 6.

The method 1200 can include the user 10 triggering, via the UI, configuration of all or a subset of the sensors 402 (1210). The user 10 can select, via the UI, all of the sensors 402 or a subset thereof for configuration, and then triggers a configuration session to cause the VS3 device 404 to configure the selected sensors all at once (e.g., in a single configuration session). Once the sensors 402 to be configured are selected, the user 10 can trigger the configuration process for the selected sensors via a single interaction, e.g., a click, a button-push, a touch or a vocal interaction, with the UI.

The method 1200 can include the user 10 downloading a sensor configuration log file (1212), and updating a vehicle commissioning checklist (1214). Once the configuration process is completed for the selected sensors, the user 10 can download a configuration log file generated by the VS3 device 404 and including a log of the configuration process. The configuration log file can include a separate configuration log for each sensor 402. The user 10 can update a commissioning checklist of the vehicle 100 associated with the sensors 402 based on the configuration log file or the configuration logs of the sensors 402.

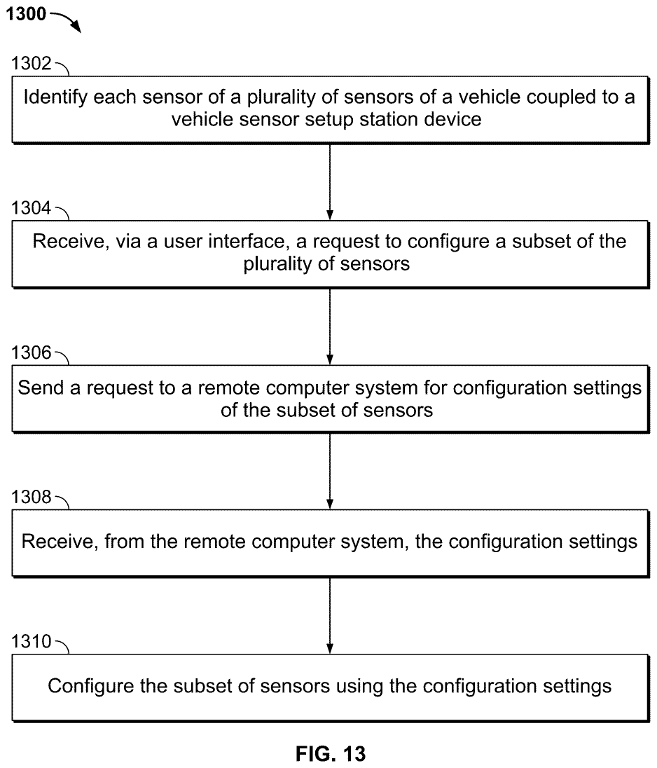

FIG. 13 is a flowchart of a method 1300 for automatic configuration of vehicle sensors, according to an example embodiment of the current disclosure. The method 1300 can be executed or performed by the VS3 device 404. In brief overview, the method 1300 can include identifying each sensor of a plurality of sensors coupled to the VS3 device 404 (1302), receiving, via a UI, a request to configure a subset of the plurality of sensors (1304), sending a request to a remote computer system for configuration settings of the subset of sensors (1306), receiving, from the remote computer system, the configuration settings (1308), and configuring the subset of sensors using the configuration settings (1310). As discussed above, the VS3 device can be an edge device, and most of the processing for configuring the sensors 402 can be performed at the VS3 device 404.

At 1302, the VS3 device 404 can identify each sensor of a plurality of sensors coupled to the VS3 device 40. Each sensor 402 can automatically send its serial number to the VS3 device 404. For each sensor 402, the VS3 device 404 can use the serial number of the sensor to determine a type, a make and/or a model of the sensor 402. For example, the VS3 device 404 can access a database or a data structure to determine or obtain more information about the sensor 402 using the sensor serial number. The VS3 device 404 can determine or assign, for each sensor 402, a name to the sensor 402. For example, the VS3 device 404 can determine the name of a sensor 402 using the sensor type, the sensor make, the senor model, a port or connector 410 associated with the sensor 402 and/or other information about the sensor 402. In some implementations, each sensor 402 can send its name, e.g., with the sensor serial number, to the VS3 device 404.

At 1304, he VS3 device 404 can receive, via the UI, a request to configure a subset of the plurality of sensors. The UI can be provided by the VS3 device 404 and/or the remote system 406. For example, the UI can be or can include a web user interface hosted by the VS3 device 404. User devices 408 can access the web user interface via an IP address of the VS3 device 404. In some implementations, the UI can be accessible via a webpage or a cloud application provided by the remote system 406. As discussed above, the user device 408 can be a local user device 408a connecting to the VS3 device 404 via the wireless edge router 906 or a remote user device 408b connecting to the VS3 device 404 via the remote system 406. Once the VS3 device 404 is powered on and the sensors 402 are connected to the VS3 device, the sensor configuration process can be managed via a local user 10a or remote user 10b. The user 10 can select all or a subset of the sensors 402 to be configured and initiates the configuration process via the UI. In response, the user device 10 can send a request to the VS3 device 404 to configure the selected sensors 402. The request can include information indicative of the selected sensors 402. For example, the request can include the serial numbers and/or other identification information of the selected sensors.

At 1306, the VS3 device 404 can send a request to a remote computer system 406 for configuration settings of the subset of sensors. The remote computer system 406 can maintain desired or expected configuration settings for various types of sensors. The VS3 device 404 can request, from the remote system 406, the configuration settings for all the sensors 402 connected to the VS3 device 404 or the selected sensors. The request can include information identifying the sensors 402 for which the configuration settings are requested. For example, the request can include the serial numbers and/or other identifying information of the sensors for which the configuration settings are requested.

At 1308, the VS3 deice 404 can receive, from the remote computer system 406, the configuration settings. The remote computer system 406 can maintain, for each sensor type, make and/or model, a corresponding set of configuration settings. The set of configuration settings for each sensor type, make and/or model can include the configuration settings for sensors of the sensor type, make and/or model. Upon receiving the request from the VS3 device 404, the remote computer system 406 can send the desired or expected configuration settings for all or the selected subset of sensors to VS3 device 404.

The plurality of sensors 402 can include one or more radar sensors 210, one or more LiDAR sensors 212, one or more cameras 214, and/or one or more IMUs 224, among other sensors. The configuration settings for each LiDAR sensor 212 can include at least one of firmware update data, an internet protocol (IP) address for the LiDAR sensor, or one or more upload scan patterns. The firmware update data can include at least one of a firmware version, a link to download the firmware of a specific version and/or an encrypted version of the firmware of the specific version. The VS3 device 404 can be configured to check that the firmware of LiDAR sensors 210 is current or matches the firmware update data, and update the firmware, e.g., if not current, based on the firmware update data. The IP address enables communications with the LiDAR sensor 212. The one or more upload scan patterns (or simply scan pattern(s)) can specify the scan pattern(s) supported by the sensor LiDAR sensor 212 and/or category thereof. For example, the supported scan pattern(s) can imply or dictate the field of view (FOV) or horizontal FOV of the LiDAR sensor 212. The FOV of the LiDAR sensor 212 can be characterized as narrow FOV or wide FOV, depending on the angular range of the supported scan pattern(s).

The configuration settings for each radar sensor 210 can include at least one of firmware update data or an IP address for the radar sensor 210. The firmware update data can include at least one of a firmware version, a link to download the firmware of a specific version and/or an encrypted version of the firmware of the specific version. The IP address enables communications with the radar sensor 210. The VS3 device 404 can be configured to check that the firmware of radar sensors 210 is current or matches the firmware update data, and update the firmware, e.g., if not current, based on the firmware update data.

In some implementations, the configuration settings for each camera 214 can include corresponding visualization check data. The visualization check data can include one or more instructions or commands to acquire one or more images or one or more video sequences from the camera 214. The captured image(s) or video sequence(s) can be used to check that the camera 214 is operating properly.

In some implementations, the configuration settings for each IMU can include functional check data. The IMU functional check data can include an instruction or command to acquire a set of readings from the IMU sensor 224 to be used to verify if the IMU sensor 224 is functioning properly. For example, the requested readings can include linear acceleration measurements from the accelerometer(s) of the IMU and angular velocity measurements from the gyroscope(s) of the IMU across all axes, e.g., x, y and z axes. The remote computer system 406 can send to the VS3 device 404 information indicative of other specific settings of the IMU 224, such as the IMU sampling rate, the data output format, and/or other parameters, which determine how the IMU 224 collects and reports its data.

At 1310, the VS3 device 404 can configure the selected subset of sensors using the configuration settings received or acquired from the remote computer system 406. The VS3 device 404 can configure the selected subset of sensors all at once in a single configuration session, e.g., simultaneously or serially responsive to a request from the user device 408. The VS3 device 404 can request or instructions from the user device 10 can trigger the configuration of the selected subset of sensors, and in response configure the selected subset of sensors serially or in parallel all at once. For example, the user 10 can trigger the configuration of the selected sensors by interacting with visual item of the UI and, in response, the user device 408 can send a command or instruction to the VS3 device 404 to configure the selected subset of sensors. The command or instruction can include information identifying the selected subset of sensors. The selected subset of sensors can include all the sensors 402 or a smaller subset thereof, e.g., less than all the sensors 402. Upon receiving the command or instruction, the VS3 device 404 can configure the selected subset of sensors in a single configuration session. In some implementations, the VS3 device 404 can configure the selected subset of sensors concurrently or in parallel. In some implementations, the VS3 device 404 can configure the selected subset of sensors serially in a single configuration session, e.g., responsive to a single triggering command or instruction from the remote computer system 406.

In configuring a radar sensor 210, the VS3 device 404 can update the firmware of the radar sensor 210 to match a specified firmware version. In some implementations, the VS3 device 404 can download the firmware update from the remote computer system 406 or a manufacturer's website and install the firmware update into the radar sensor 210. In some implementations, the VS3 device 404 can trigger the radar sensor 210 to automatically update its firmware. For example, the radar sensor 210 can (over Wi-Fi) provide by the VS3 device 404 to a network and update its firmware. The VS3 device 210 can transmit the desired IP address to the radar sensor 210, and cause the IP address to be entered or stored at the radar sensor 210.

In configuring a LiDAR sensor 212, the VS3 device 404 can update the firmware and IP address of the LiDAR sensor 212 in a similar way as discussed above with regard to the radar sensor 210. The VS3 device 404 can configure the LiDAR sensor 212 with the desired or expected scan pattern(s) received from the remote computer system 406. The VS3 device 404 can cause each camera 214 in the selected subset of sensors to capture one or more images and/or one or more video sequences and send the captured image(s) and/or video sequence(s) to the VS3 device 404. The VS3 device 404 can also cause each IMU 224 in the selected subset of sensors to generate readings or measurements and send the generated readings or measurements back to the VS3 device 404.

The VS3 device 404 can communicate with the plurality of sensors 402 through an open systems interconnection (OSI) layer lower than the application layer. The OSI layer used to communicate with each sensor 402 can depend on the type, make and/or model of the sensor. Using OSI layers lower than the application layer to communicate with the sensors 402 allows the VS3 device 404 and the software integrated therein to be independent of configuration tools provided by manufacturers of the sensors 402, and to support various types of sensors.

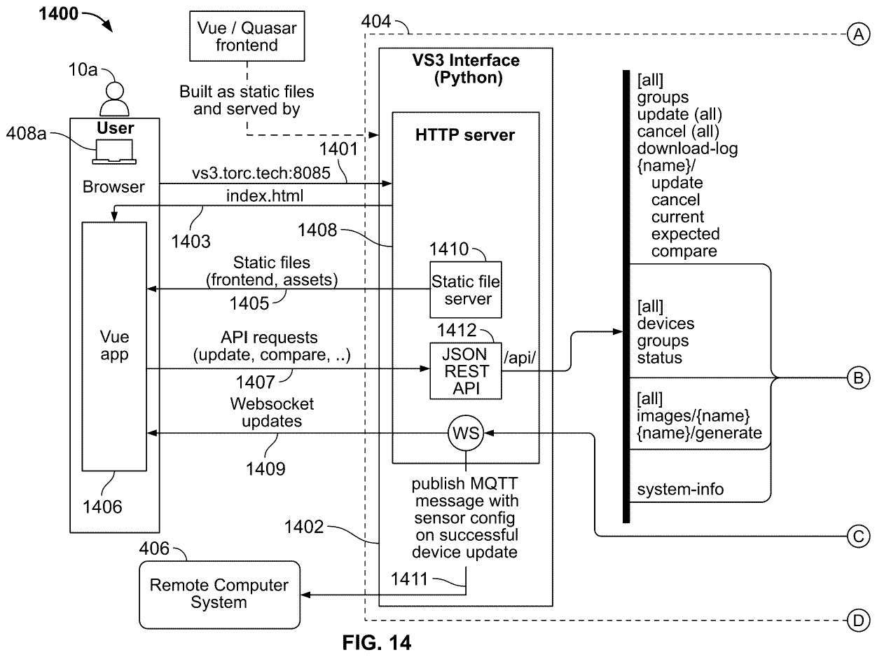

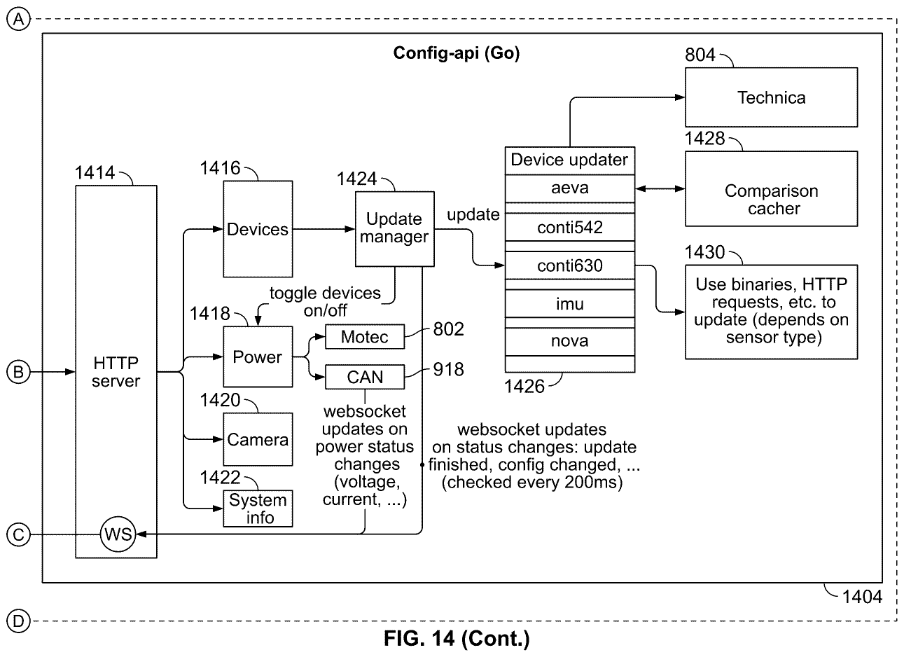

Referring now to FIG. 14, a block diagram depicting an architecture of a sensor configuration software 1400 according to an example embodiment of the current disclosure is provided. The configuration software 1400 can be installed and executable at the VS3 device 404. The configuration software 1400 can include a VS3 interface 1402, a backend sensor configuration server 1404 and a frontend application 1406. The backend sensor configuration server 1404 can also be referred to herein as an edge-based sensor configuration server, or an edge-based sensor configuration application.

The VS3 interface can include a hypertext transfer protocol (HTTP) server 1408. The HTTP server 1408 can include a static file server 1410 and an application interface programming (API) server 1412. The local user device 408a can send a request 1401 for the frontend application 1406 or webpage thereof to the HTTP server 1408. In response, the HTTP server 1408 can send the webpage 1403 of the frontend application 1406 to the local user device 408a. The frontend application 1406 can be a web-based application or a website providing a UI for managing the sensor configuration. The static server 1410 can provide or send, at 1405, static assets or files, such as images, logos and/or fonts, to the frontend application 1406 to be rendered or displayed on a UI to a user 10, e.g., local user 10a. For example, the frontend application 1406 can be built using static files and that are provided by the static server 1410. The local user 10a can use the frontend application or the respective UI to select a subset of sensors, from the plurality of sensors 402 connected to the VS3 device 404, to be configured, and initiate or trigger the configuration of the selected subset of sensors. The user 10a can interact with the frontend application or the respective UI to trigger the configuration of the subset of sensors. In response, the frontend application 1406 can send a request 1407 for configuring the selected subset of sensors to the API server 1412. In some implementations, the API server 1412 can be configured to use representational state transfer (REST) APIs to communicate with backend sensor configuration application or components thereof, and the API server 1412 can be referred to as REST API server. The request 1407 can include, or can also be, a request for validating the sensor configurations once the sensors are configured. The request 1407 can include information identifying the sensors 402 to be configured. For example, the request 1407 can include serial numbers or other identifiers of the sensors 402 to be configured.

The VS3 interface 1402 can be configured to interface with user devices 10 and/or the remote computer system 406. Remote user devices 10b can communicate with VS3 device 404 and/or the VS3 interface 1402 via the remote computer system 406. In some implementations, the VS3 interface 1402 can communicate with the remote computer system 406 or a respective IoT core via the WebSocket (WS) communication protocol. The WS protocol enables or allows real-time, two-way data transfer between the VS3 device 404 and the remote computer system 406 or the corresponding IoT core. In some implementations, the VS3 interface 1402 can be implemented using Python.

The backend sensor configuration server 1404 can also be referred to herein as backend sensor configuration service. The backend sensor configuration server (or application) 1404 can include an HTTP server 1414, sensor driver module 1416, a power module 1418, a camera driver module 1420, a system-information module 1422, a configuration manager 1424, a sensor updater 1426, a validation module 1428 and a sensor communication module 1430. The backend sensor configuration server 1404 can be configured to handle, perform or execute the configuration of the selected subset of sensors. In some implementations, the backend sensor configuration server 1404 can be implemented using the GO programming language.

The API server 1412 can determine, based on the request 1407 received from the frontend application 1406, one or more APIs to execute the sensor configuration process, and send the APIs to the HTTP server 1414. The HTTP server 1414 can distribute the APIs to distinct modules or components of the backend sensor configuration server 1404. The HTTP server 1414 can distribute the APIs to sensor driver module 1416, the power module 1418, the camera driver module 1420 and the system-information module 1422. For example, the APIs can include one or more APIs for the sensor driver module 1416 to set or update the configuration settings of one or more sensors, e.g., radar sensor(s) 210, LiDAR sensor(s) 212 and/or IMUs 224, download one or more configuration log(s), validate the performed configuration(s) of the sensors, e.g., by comparing the configuration log to corresponding expected or desired configuration settings, and/or cancel an on-going configuration. The sensor driver module 1416 can be configured to maintain sensor driver libraries for various sensors 402, e.g., radar sensor(s) 210, LiDAR sensor(s) 212 and/or IMUs 224. The sensor driver libraries can include a collection of software functions that enables the VS3 device 404 to interact with and read data from various sensors 402. In some implementations, the sensor driver module 1416 can include a separate sensor driver library for each sensor type, make and/or model.

The APIs can include one or more APIs for the power module 1418 to configure power supply for sensors 402 connected to the VS3 device 404. The power module 1418 can include or implement one or more functionalities to trigger commands of the power distribution module 802 to turn sensors 402 on or off. The power module 1418 can receive an indication of the selected sensors and/or corresponding connectors 410 or ports. The power module 1418 may receive an indication of whether the selected sensors are to be configured serially or in parallel. The power module 1418 can manage the power connections to various connectors 410 and/or respective power ports based on the received information. For example, the power source module 1418 can switch connections on or off, and/or set or adjust voltages and/or currents associated with the connections. The power module can send commands or instructions to the power distribution module 802 to switch a connection on or off and/or adjust the voltage or current of the connection, e.g., based on the sensor 402 associated with that connection. The power module 1418 can report updates on power status changes, e.g., via the CAN card 908 and the WS protocol, to the frontend application 1406 running on a user device 10.

The APIs can include one or more APIs for the camera driver module 1420 to capture or acquire one or more images and/or one or more video sequences. The camera driver module 1420 can include or maintain camera driver functionalities. The camera driver module 1420 can be configured to maintain camera driver libraries for certain camera types, makes and/or models. The camera driver libraries can include a collection of software functions that enables the VS3 device 404 to interact with and acquire image and/or video data from various cameras 214. The camera driver module 1420 can use functions from the camera driver libraries to cause one or more cameras 214 to acquire or capture one or more images or video sequences requested by the frontend application 1406. The camera driver module 1420 can send one or more functions from the camera driver libraries to the configuration manager 1424. The configuration manager 1424 can send the function(s) for interacting with the cameras 214, e.g., received from the camera driver module 1420, to the sensor updater 1424 for commanding the cameras 214.

The APIs can include one or more APIs for the system-information module 1422. The system-information module 1422 can store, maintain, manage and/or present system information such as software version, OS version and/or other system information.

The sensor driver module 1416 can store and/or maintain sensor driver configuration codes and can send one or more functions from the sensor driver libraries to the configuration manager 1424. The configuration manager 1424 can determine whether the sensors 402 are to be configured in parallel or serially. In the case of serial configuration of the selected subset of sensors, the configuration manager 1424 can determine an order according to which to configure the sensors 402. The configuration manager 1424 can send the functions for interacting with the sensors 402, e.g., received from the sensor driver module 1416, to the sensor updater 1424. In the case of serial configuration, the configuration manager 1424 can send the functions for interacting with the sensors 402 to the sensor updater 1426 according to the order for configuring the sensors or can send an indication of the sensor configuration order to the sensor updater 1424.

The sensor updater 1426 can interact with the sensors 402 and execute the configurations for various sensors 402. For example, the sensor updater 1426 can update the firmware and the IP addresses of the radar sensors 210, and update the firmware, the IP addresses and/or the scanning pattern(s) of the LiDAR sensors 212. The sensor updater 1426 can request, command, or instruct the cameras 214 to capture or acquire images and/or video sequences. The sensor updater 1426 can request, command, or instruct the IMUs 224 to record or acquire measurements of kinematic parameters, such as linear acceleration and angular velocity. In the case of serial configuration of sensors 402, the sensor updater 1426 can maintain a queue of requests or APIs to configure the selected subset of sensors. The queue of requests or APIs can be arranged or ordered according to a configuration for configuring the sensors 402, e.g., in a serial configuration. The sensor updater 1426 can communicate with the sensors 402 via one or more Ethernet switches 804. In some implementations, the sensor updater 1426 can send to the power module 1418 information indicative of an order or schedule for configuring the sensors 402, and the power module 1418 can use the information from the sensor updater 1426 to manage the power connections with the sensors 402.

The sensor updater 1426 can access the communication module 1430 to determine, for each sensor 402, the communication protocol(s) or the communication procedure(s) to be used to communicate with the sensor 402. The communication module 1430 can maintain, information indicative of the communication protocol(s) or the communication procedure(s) associated with different sensor types, makes and/or models. The communication protocols or procedures can include binaries, HTTP requests and/or other communication methods.

The sensor updater 1426 can receive or acquire, from the sensors 402, data associated with the configuration process or configuration session, such as updated configuration settings of radar sensors 210 and LiDAR sensors 212, images and/or video sequences captured by the camera(s) 214 and/or measurements recorded by the IMUs 224. The sensor updater 1426 can provide the data associated with the configuration process or a portion thereof to the validation module 1428. The validation module 1428 can compare the updated sensor settings to corresponding expected or desired settings, e.g., received from the remote computer system 406. The updated configuration settings for a given sensor 402 are considered to be valid if they match the corresponding expected or desired settings received from the remote computer system 406. For an IMU 224, the validation module 1428 can compare measurements received from the IMU 224 to expected measurements. The sensor updater 1426 can provide comparison results for configured sensors 402 to the configuration manager 1424, e.g., for sharing with the frontend application 1406 and/or the remote computer system 406. The sensor updater 1426 can provide images and/or video sequences received from the cameras 214 to the configuration manager 1424 and/or the camera module 1420 for storing and/or sharing with the frontend application 1406 and/or the remote computer system 406.

The configuration manager 1424 can monitor the configuration process and send updates of the configuration process to a user device 408 or the frontend application 1406 running thereon. For example, the configuration manager 1424 can monitor communications or data, e.g., configuration logs or configuration status data, received from the sensor(s) being configured or the configured sensors. The configuration manager 1424 can send updates of the configuration process to the frontend application 1406 periodically, e.g., every 100 milliseconds (ms), 200 ms, 300 ms or other period. The configuration manager 1424 can send configuration updates to the frontend application 1406 and/or the user device 408 via the message(s) 1409. The configuration updates can include information indicative of configuration status or progress, updated configuration settings, validation information (e.g., comparison results from the validation module 1430) of updated configuration settings and/or configuration log(s). The configuration updates can include images and/or video sequences captures by one or more cameras 214. The configuration updates can include measurements of kinematic parameters recorded or acquired by one or more IMUs 224.

The configuration manager 1424 can communicate sensor configuration updates to the remote computer system 406, e.g., via the message(s) 1411. For example, the configuration manager 1424 can send information indicative of successful or failed configuration, e.g., per sensor 402, to the remote computer system 406. The configuration manager 1424 can send updated configuration settings for various sensors 402 to the remote computer system 406. The configuration manager 1424 can send sensor configuration logs or a configuration log file to the remote computer system 406. The configuration manager 1424 can send images and/or video sequences captures by one or more cameras 214 to the remote computer system 406. The configuration manager 1424 can send measurements of kinematic parameters recorded or acquired by one or more IMUs 224 to the remote computer system 406. In some implementations, the configuration manager 1424 can communicate with the remote computer system 406 or an IoT core associated with the remote computer system 406 using the WS protocol and/or the message queuing telemetry transport (MQTT) messaging protocol.

In some implementations, the configuration manager 1424 can be implemented or integrated in the VS3 interface 1402, e.g., instead of the backend sensor configuration server 1404. The configuration manager 1424 can communicate with the HTTP server 1414 to command or request configuration of the selected subset of sensors, and/or request or receive configuration updates and configuration logs. The configuration manager 1424 can communicate with the remote computer system 406 or an IoT core associated with the remote computer system 406 using the WS protocol and/or the MQTT messaging protocol to requested expected configuration settings of sensors 402 and/or report configuration updates including configuration logs.

In some implementations, the VS3 device 404 may include the backend sensor configuration server 1404 but not the VS3 interface 1402. The frontend application 1406 can communicate directly with the HTTP server 1414. The static file server 1410 and the API server 1412 can be implemented or integrated in the HTTP server 1414. The configuration manager 1424 can communicate with the remote communication system 406 or the IoT core associated with the remote communication system 406 using the MQTT messaging protocol.

FIG. 14 depicts an example software architecture for sensor configuration that is provided for illustrative purposes. At a high level, the frontend application 1406 can provide a website application to the user 10. The frontend application 1406 can interface with an HTTP server, e.g., HTTP server 1408 and/or 1414, of the VS3 device 404. The HTTP server 1408 and/or 1414 receives user requests, such as clicking or interacting with an update button or icon, and provides the requests to the backend sensor configuration server 1404. The backend sensor configuration server 1404 can store or maintain all the sensor driver libraries used to execute communications with the sensors 402 directly to update sensor configuration parameters, e.g., sensor firmware or sensor IP address and/or acquire sensor measurements or camera images.

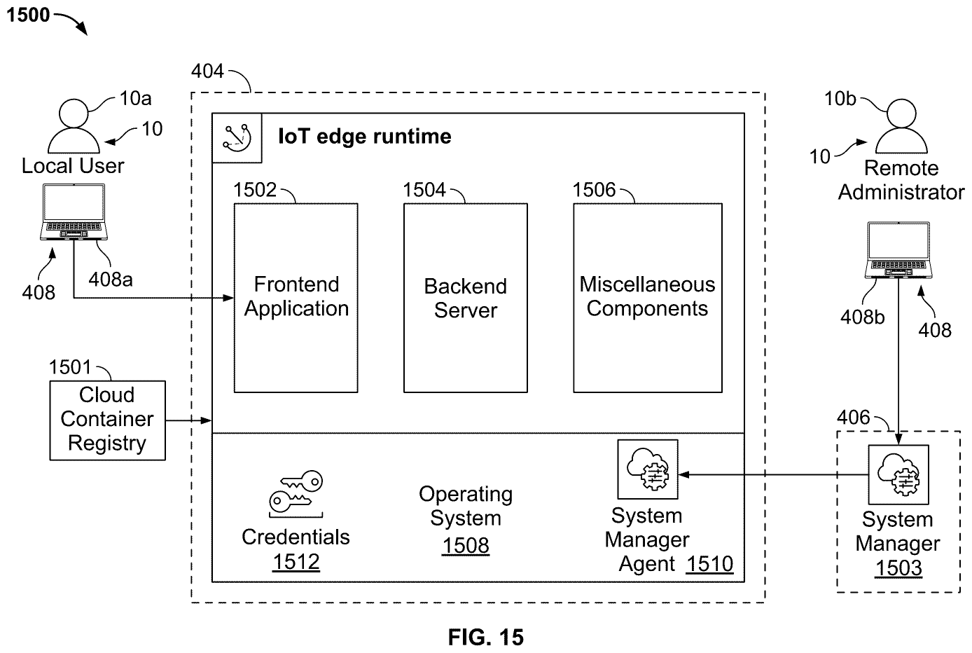

FIG. 15 is a block diagram depicting a high-level software architecture 1500 for sensor configuration, according to an example embodiment of the current disclosure. The software architecture 1500 can include a frontend application 1502 to be provided for execution on a local user device 408a or a remote user device 408b, a backend server 1504 including APIs for configuring the sensors 402 and other miscellaneous components 1506. The frontend application 1502, the backend server 1504 and/or the miscellaneous components 1506 can be implemented as components of IoT edge runtime. The IoT edge runtime can make the VS3 device 404 an IoT edge device. In particular the IoT edge runtime components can enable the VS3 device 404 acting as an IoT edge device to receive code to run and configure sensors at the edge and communicate the configuration results back to the remote computer system 406. The VS3 device 404 can obtain or acquire software images of components or modules of the IoT edge runtime from a cloud container registry 1501. The frontend application 1502, the backend server 1504 and/or the miscellaneous components 1506 can run on top of an operating system 1508. The operating system 1508 can be custom built using the remote system 406 or a cloud system thereof. The operating system 1508 can run a system manager agent 1510 to allow cloud access and monitoring. In particular, the system manager agent 1510 can allow communication with a system manager 1503 of the remote computer system 406. The operating system 1508 can be encrypted using credentials associated with the system manager 1503. The system manager 1503 can be referred to herein as a cloud system manager, and the system manager agent 1510 can be referred to herein as a cloud system manager agent.

In some implementations, local device 408a, e.g., a laptop, smartphone or tablet, connects to the VS3 device 40, e.g., via Wi-Fi provided by the VS3 device 404. The local user 10a can access the frontend application 1502 or webpage thereof on a browser of the user device 10a without having to run other software on the local user device 408a. For example, the local user 10a can connect to Wi-Fi, reach the webpage and start configuring the sensors 402. In some implementations, a remote user device 408b can connect to the VS3 device 404 via the remote computer system 406 or the respective system manager 1503. For example, once the VS3 device 404 is turned on and connected to the sensors 402, a remote user 10b can access the frontend application 1502 or a respective webpage via the remoter user device 408b. The remote user device 408b and/or the webpage can communicate with the backend server 1504 via the system manager 1503 running on the remote computer system 406 and the system manager agent 1510 running on the VS3 device 404.

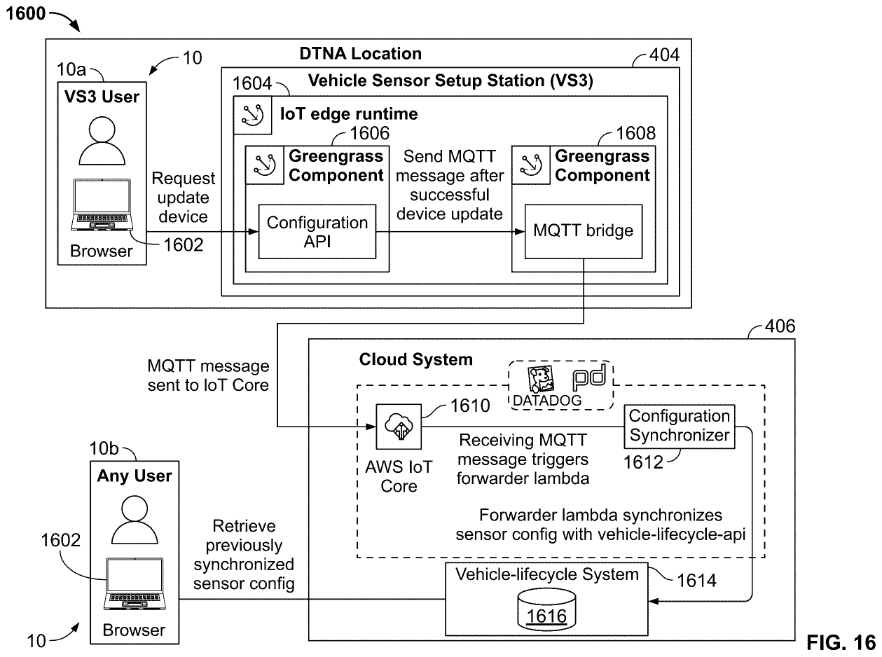

FIG. 16. is a block diagram depicting a high-level software architecture 1600 for cloud-based sensor configuration, according to an example embodiment of the current disclosure. The software architecture 1600 can be viewed as representing an example software architecture of the configuration platform 400 of FIG. 6. The local user 10a can use a browser 1602 running on a local user device 408a to select a subset of sensors and request or trigger configuration of the selected subset of sensors. The VS3 device 404 can include an IoT edge runtime 1604 having a first IoT edge runtime component 1606 for configuring sensors 402 and a second IoT edge runtime component 1608 for communicating with the remote computer system (or cloud system) 406. The first component 1606 can receive a sensor configuration request generated by the local user 10a and execute or perform the sensor configuration according to the received request. The second component 1608 can act as a messaging bridge and report sensor configuration results to the remote computer system 406. The remote computer system 406 can remotely update and monitor the IoT edge runtime 1604 and/or components thereof. Once a sensor 402 is configured, the second component 1408 can transmit information indicative of successful sensor configuration to the cloud system 406, e.g., using the MQTT protocol.

The cloud system 406 can include an IoT core 1610, a configuration synchronizer 1612 and a vehicle-lifecycle system 1614. The IoT core 1610 can communicate with the VS3 device 404 and/or the second component 1608. Messages received from the VS3 device 404 indicative of sensor configuration updates, e.g., messages indicative of which sensor was updated and configuration specifics, can trigger the configuration synchronizer 1612 to synchronize the vehicle-lifecycle system 1614 with the information indicative of the sensor configuration updates. The vehicle-lifecycle system 1614 can include a database 1616 to store configuration logs, sensor calibration logs, maintenance logs and/or other information related to vehicle 100 over time. The vehicle-lifecycle system 1614 and/or the database 1616 can provide APIs for updating the database 1616 with configuration logs and/or other configuration information received from the VS3 device 404. The vehicle-lifecycle system 1614 and/or the database 1616 can provide APIs for accessing data stored in the database 1616. For example, a remote user 10b can access the vehicle-lifecycle system 1614 and/or the database 1616, e.g., via browser 1602 running on a remote user device 408b, to retrieve or acquire sensor configuration data stored therein. In some implementations, the remote user device 408b can communicate with the VS3 device 404 via the IoT core 1610 to manage a sensor configuration session, e.g., instead of the local user device 408a.

In some implementations, the sensor configuration platform 400 can be implemented according to any of the software configurations 1400, 1500 or 1600, or a combination thereof. The sensor configuration platform 400 can include or can be implemented using an IoT platform, which allows for supporting a plurality of edge computing devices, such as VS3 devices 404, for configuring sensors. Performing or executing the sensor configuration using edge computing makes the sensor configuration process faster and more efficient. In particular, using edge computing reduces the amount of communication between the remote computer system 406 and VS3 device 404, e.g., compared to performing the sensor configuration centrally at the remote computer system 406.

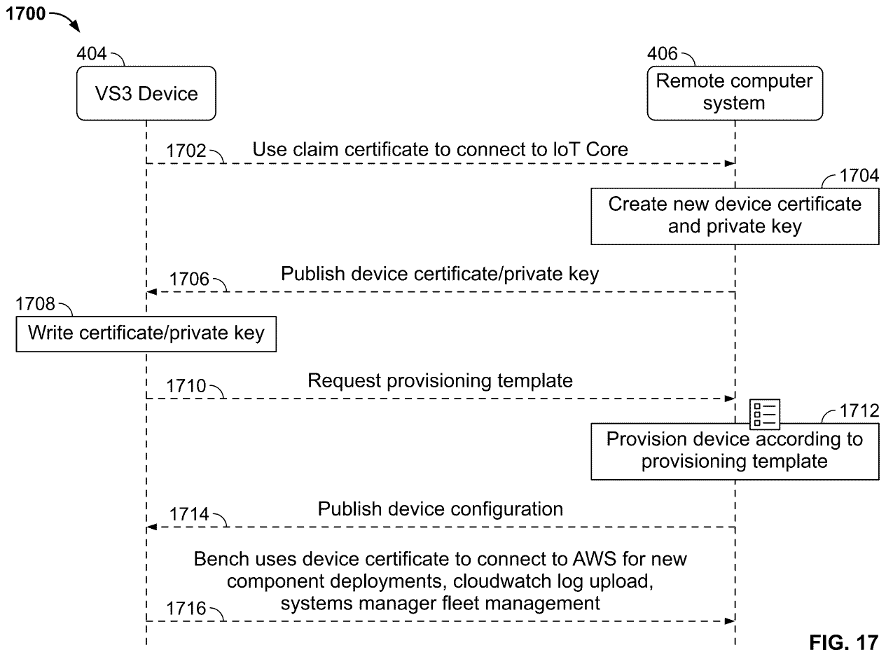

Referring now to FIG. 17, a signaling diagram 1700 depicting communications between the VS3 device 404 and the remote computer system 406 is shown, according to an example embodiment of the current disclosure. The VS3 device 404 can send a claim certificate 1702 to the remote computer system 406 or the respective IoT core 1610. The claim certificate 1702 is a temporary certificate that can be used by the VS3 device 404 to initially connect to the remote computer system 406 and request a unique, permanent device certificate for the VS3 device 404. The claim certificate 1702 can include an identifier of the VS3 device 1702 to enable verification of the identity of the VS3 device 4004 before granting full access to the remote computer system 406. It is to be noted that the remote computer system 406 can be configured to provide IoT access to a plurality of VS3 devices 404 or edge computing devices.

In response to receiving the claim certificate 1702, the remote computer system 406 or the IoT core 1610 can create or generate a device certificate and a private key for the VS3 device 404 (1704), and send the device certificate and the private key to the VS3 device (1706). The IoT core 1610 and/or the remote computer system 406 can be configured to generate, for each VS3 device 404 or edge computing device, a corresponding device certificate and/or a private key to secure communications with the VS3 device 404 or edge computing device. The device certificate and/or the private key can be used to encrypt or decrypt messages exchanges between the VS3 device 404 and the remote computer system 406.

The VS3 device 404 can store the device certificate and/or private key received from the remote computer system 406 (1708) for use to secure communications with the remote computer system 406. The VS3 device 404 can send a request 1710 for provisioning templates associated with the VS3 device 404 to the remote computer system 406. The remote computer system 406 can maintain provisioning templates for provisioning the VS3 device 404 with target sensor configuration settings for various sensor types, makes and/or models. The remote computer system 406 can determine, responsive to the request 1710, to provision the VS3 device 404 according to the provisioning templates maintained at the remote computer system 406 (1712). The VS3 device 404 can send the request 1710 upon starting or upon being turned on. The provisioning templates can be or can include configuration files that are parsed by the VS3 device 404 when the VS3 device 404 starts. The configuration files can provide the VS3 device 404 the hardware and target sensor configuration settings, such as network ports, target IP addresses, groupings, etc. The configuration files make the VS3 device 404 and frontend application 1406 less hardware dependent, since a new configuration can be produced, and upon server reset, the new configuration will be loaded.

Responsive to the request 1710, the remote computer system 406 can send provisioning templates including configuration settings for the sensors 402 (1714). The configuration settings provided by the remote computer system 406 represent the target, expected or desired configuration settings for the sensors 402.

The VS3 device 404 can use the received device certificate and/or the private key to connect to the remote computer system 406, e.g., to provide sensor configuration updates as part of a sensor configuration session, access logs of the vehicle 100 stored in the remote computer system 404 or the vehicle-lifecycle system 1614 and/or manage a fleet of vehicles. For example, the VS3 device 404 can connect to the remote computer system 406 to send sensor configuration results to the remote computer system 406 during the production phase or at a later stage when one or more new sensors are to be deployed in the vehicle 100. The user 10 can access the remote computer system 406 or the vehicle-lifecycle system 1614 to check various logs associated with the vehicle 100. The user 10 can access the remote computer system 406 to manage and/or monitor a fleet of vehicles, e.g., with respect maintenance activities, sensor calibration and/or mission management and control.

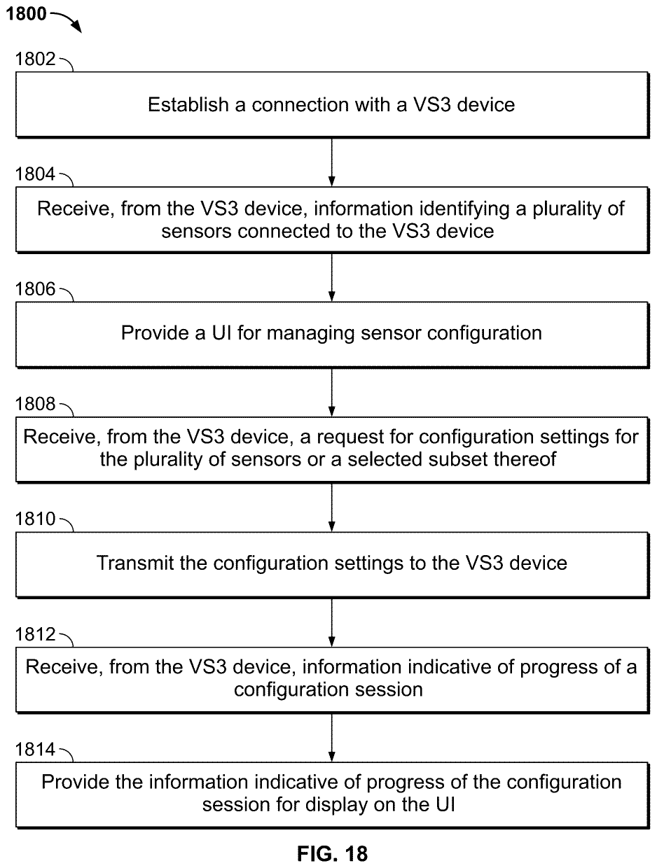

FIG. 18 is a flowchart illustrating a method 1800 for cloud-based automatic configuration of vehicle sensors, according to an example embodiment of the current disclosure. In brief overview, the method 1800 can include establishing, by a cloud computer system, e.g., remote computer system 406, a connection with a VS3 device 404 (1802), and receiving, by the remote computer system 406 from the VS3 device 404, information identifying a plurality of sensors 402 connected to the VS3 device 404 (1804). The remote computer system 406 can provide a user interface (UI) for managing configuration of the plurality of sensors 402 at the VS3 device 404 (1806), and receive, from the VS3 device 404, a request for configuration settings for the plurality of sensors 402 or a selected subset thereof (1808). The remote computer system 406 can transmit, to the VS3 device 404, the configuration settings responsive to the received request (1810), and can receive, from the VS3 device 404, information indicative of progress of a configuration session for configuring the subset of sensors at once (1812). The remote computer system 406 can provide the information indicative of the progress of the configuration session for display in the UI (1814). The method 1800 can be performed by the remote computer system 406 and can be viewed as relating to remote management of sensor configuration.

The method 1800 can include establishing, by a cloud computer system, e.g., remote computer system 406, a connection with a VS3 device 404 (1802). As discussed above in relation with FIG. 17, establishing the connection with the VS3 device 405 can include receiving, from the VS3 device 404, a claim certificate 1702 identifying the VS3 device 404, and in response, sending a device certificate and/or a private key to the VS3 device 404. The device certificate can include the private key to secure communication between the VS3 device 404 and the remote computer system 406. The VS3 device 404 can store or write the device certificate and/or the private key in a respective memory. The VS3 device 404 can use the device certificate and/or the private key to securely connect to or communicate with the remote computer system 406.

The method 1800 can include the remote computer system 406 receiving, from the VS3 device 404, information identifying a plurality of sensors 402 connected to the VS3 device 404 (1804), and providing a user interface (UI) for managing configuration of the plurality of sensors 402 at the VS3 device 404 (1806). Referring back to FIG. 14-16, the remote user device 408 can connect to the VS3 device 404 via the remote computer system 406. The communications, e.g., 1401, 1403, 1405, 1407 and/or 1409, between the VS3 device 404 and a remote user device 408b can be performed or routed via the remote computer system 404. The remote computer system 404 can provide the frontend application 1406 or 1502 or webpage or a UI thereof from the VS3 device 404 to the user device 408b. The frontend application 1406 or the 1502 can be hosted by the VS3 device 404 and provided to remote user devices 408b via the remote computer system 406. In some implementations, the frontend application 1406 or 1502, and/or a webpage or UI thereof, can be hosted and provided by the remote computer system 406. The remote computer system 406 can receive, from the VS3 device 404, information identifying the plurality of sensors 402 connected to the VS3 device 404 (1804). In some implementations, the information identifying the plurality of sensors 402 can include, for each sensor 402, a respective serial number, sensor type, sensor make, sensor model and/or some other information identifying the sensor 402. The VS3 device 404 can receive, from the sensors 402, the information identifying the sensors and can send the information to the remote user device 408b via the remote computer system 406. Upon receiving the information identifying the sensors, the remote user device 408b can display the information identifying the sensors on the UI associated with the frontend application 1406 or 1502.

In some implementations, the UI can be configured to display, based on the information identifying the plurality of sensors, a list of visual items, each visual item representing a corresponding sensor of the plurality of sensors. The UI can enable selection of the subset of sensors, and can enable triggering a configuration session at the VS3 device 404 to configure the selected subset of sensors.

At 1808, the remote computer system 406 can receive, from the VS3 device 404, a request for configuration settings for the plurality of sensors 402 or a selected subset thereof, and at 1810 can transmit, to the VS3 device 404, the configuration settings responsive to the received request. The remote computer system 406 can maintain desired or expected configuration settings for various types, makes and/or models of sensors. The VS3 device 404 can request, from the remote system 406, the configuration settings for all the sensors 402 connected to the VS3 device 404 or a selected subset thereof. The request can include information identifying the sensors 402 for which the configuration settings are requested. For example, the request can include the serial numbers and/or other identifying information of the sensors for which the configuration settings are requested. At 1308, the VS3 device 404 can receive, from the remote computer system 406, the configuration settings. The remote computer system 406 can maintain, for each sensor type, make and/or model, a corresponding configuration or provisioning template. The configuration or provisioning template for each sensor type, make and/or model can include the configuration settings for sensors of the sensor type, make and/or model. Upon receiving the request from the VS3 device 404, the remote computer system 406 can send the desired or expected configuration settings for all or the selected subset of sensors to VS3 device 404.

The remote user 10b can trigger or initiate a configuration session to configure a selected subset of sensors at once. For example, the remote user 10b can interact with a visual item of the UI to initiate the configuration session, and in response, the user device 408b can send a request to configure the selected subset of sensors to the VS3 device 404 via the remote computer system 406. The remote computer system 406 can receive the configuration request from the user device 408b and can forward the request to the VS3 device 404. In response to receiving the configuration request, the VS3 device 404 con configure the selected subset of sensors at once either serially or in parallel (concurrently). In other words, a single configuration request can cause the configuration of the selected subset of sensors serially or concurrently.

At 1812, the remote computer system 404 can receive, from the VS3 device 404, information indicative of progress of the configuration session for configuring the subset of sensors at once. As discussed above in relation to FIG. 14, the VS3 device 404 can send configuration updates, e.g., periodically, to the frontend application 1406. For a remote user device 408b, the VS3 device 404 can send the configuration updates via the remote computer system 406. The remote computer system 406 can receive sensor configuration updates, validation data and/or configuration logs for forwarding to the frontend application 1406 or 1502 running on the remote user device 408b. Also as discussed above, e.g., in relation with FIGS. 14 and 16, the VS3 device 404 can send information indicative of successful sensor configurations and related configuration data to the remote computer system 406 for storing thereon. For example, once configuration of a sensor 402 is completed, the VS3 device 404 can send information indicative of the successful sensor configuration and/or a configuration log to the remote computer system 406, e.g., for synchronizing or updating the vehicle lifecycle database 1616.

As discussed above in relation to FIG. 16, the remote computer system 406 can maintain the vehicle-lifecycle database 1616 for storing information about a lifecycle of the vehicle. The vehicle-lifecycle system 1614 and/or the respective database 1616 can store, maintain and/or provide access to configuration data, sensor calibration data, maintenance data and/or other data related to the vehicle 100 throughout a lifecycle of the vehicle 100. The remote computer system 406 can update the vehicle-lifecycle database 1616 based on the information indicative of the progress of the configuration session or a configuration log file received from the VS3 device 404. The vehicle-lifecycle system 1614 and/or the database 1616 can provide access, for one or more user devices 10, to the vehicle-lifecycle database 1616 and/or information stored therein.

At 1814, the remote computer system 406 can provide the information indicative of the progress of the configuration session for display in the UI. Upon receiving the information indicative of the progress of the configuration session, the user device 408b can cause the received information to be displayed on the UI or the frontend application 1406 or 1502 running thereon. The remote user 10b can view the progress in configuring the sensors 402 in real time or near real time, e.g., based on the frequency according to which configuration updates are sent by the VS3 device 404.

In some implementations, the information indicative of the progress of the configuration session can include validation information indicative of validation of configured settings for the subset of sensors. As discussed above in relation to FIG. 14, the validation module 1428 can compare updated configuration settings with corresponding expected or desired configuration settings. The remote user device 408 can cause the frontend application 1406 or 1502 or the UI to display visual data indicative of the received validation data or results of the comparisons performed by the validation module 1428. For example, the UI can include visual items representing or depicting the validation information or the comparison results for the subset of sensors.

As discussed above, the sensors 402 can be of different types, makes and/or models. The configuration settings can depend on the sensor type, make and/or model. For example, the configuration settings for radar sensors 210 can include at least one of firmware update data or an IP address for the radar sensor. The configuration settings for LiDAR sensors 212 can include at least one of firmware update data, an internet protocol (IP) address for the LiDAR sensor or one or more upload scan patterns. The configuration settings for cameras 214 can include visualization check data. The configuration settings for IMUs 224 can include functional check data.

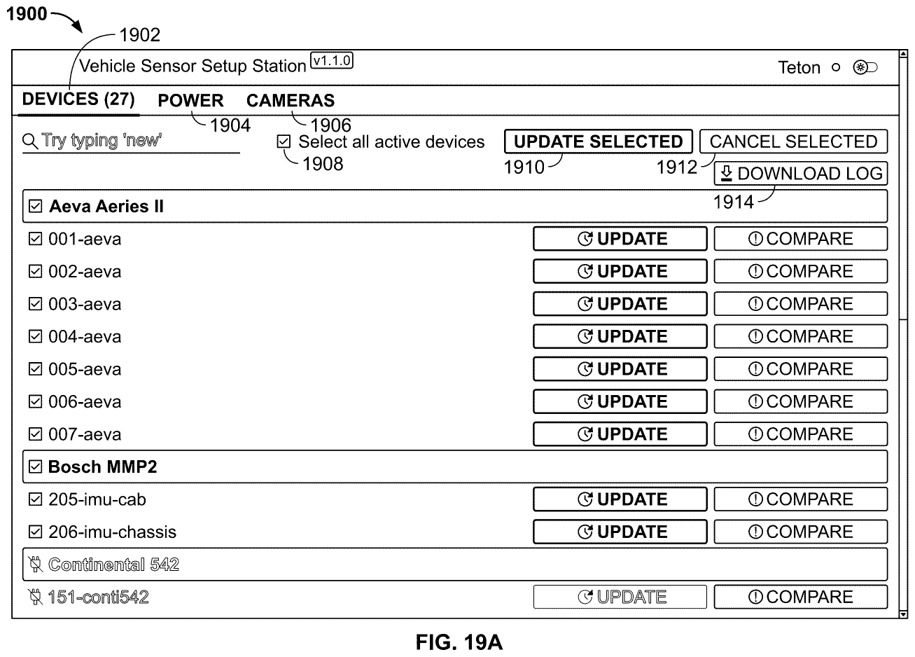

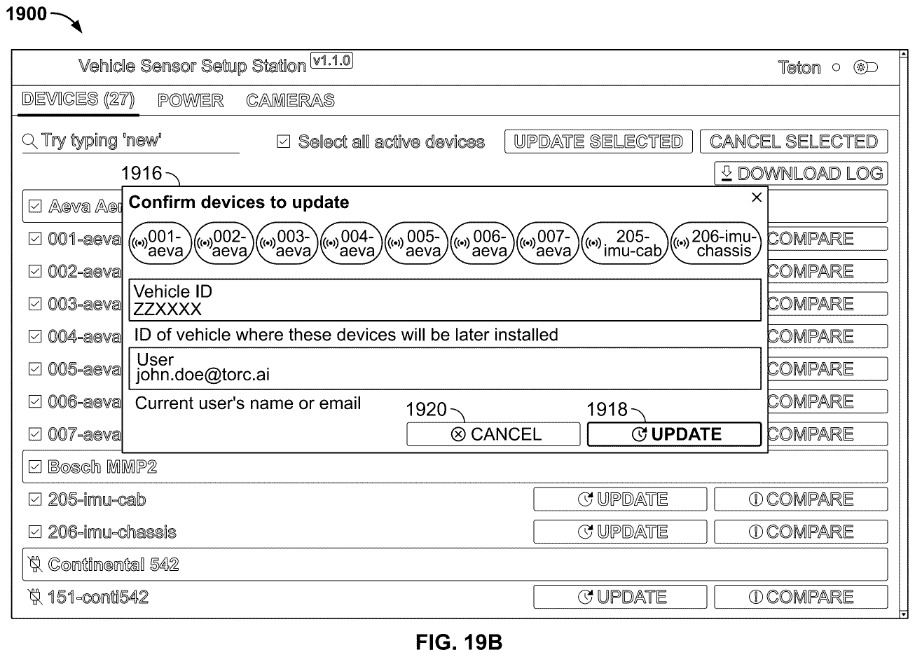

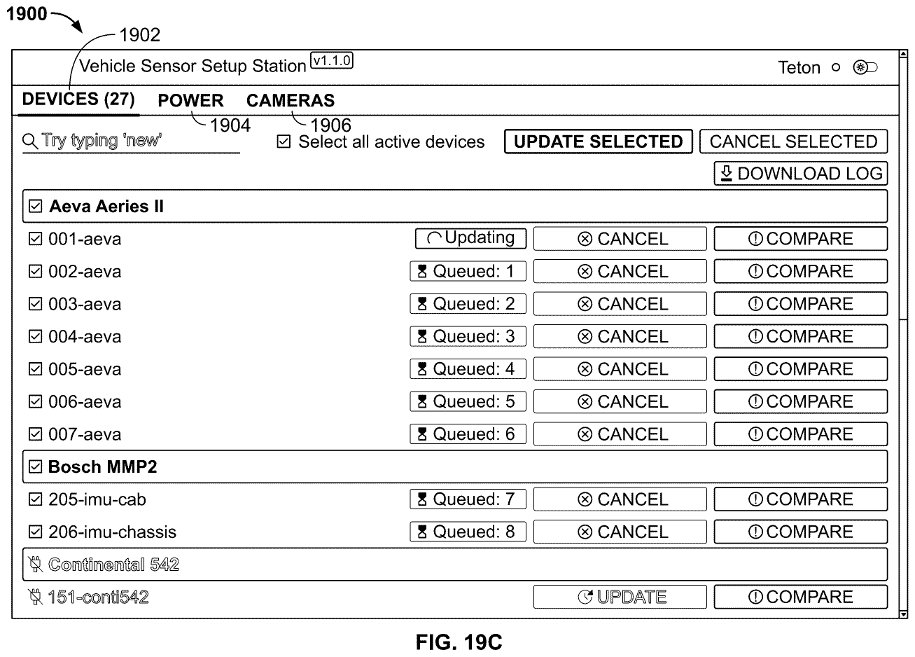

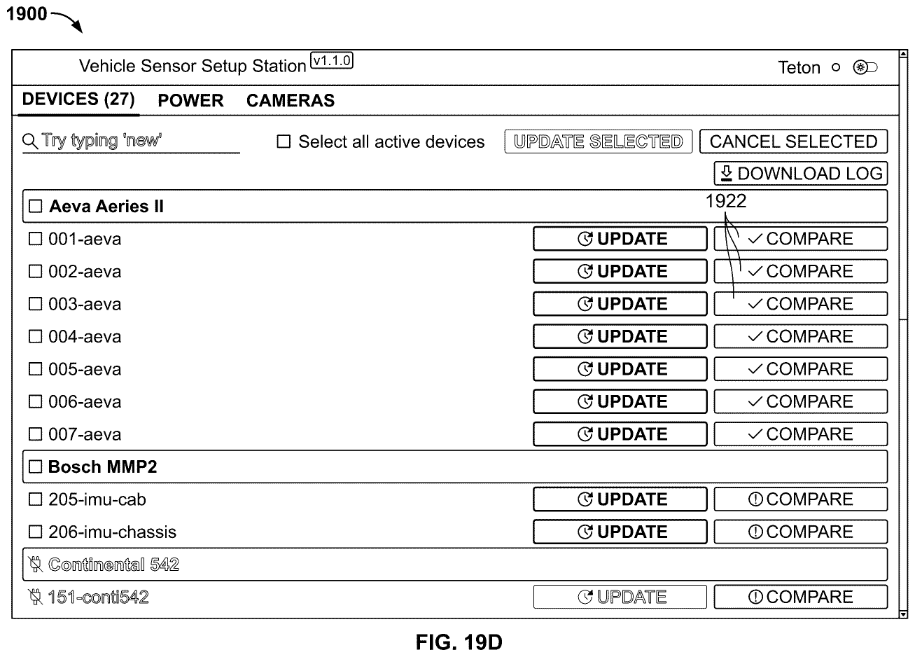

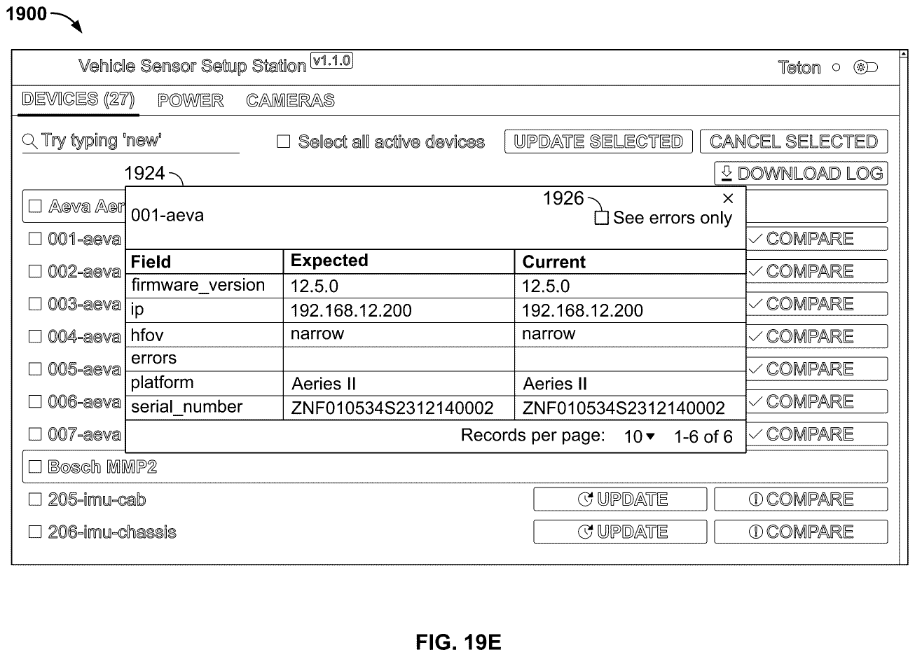

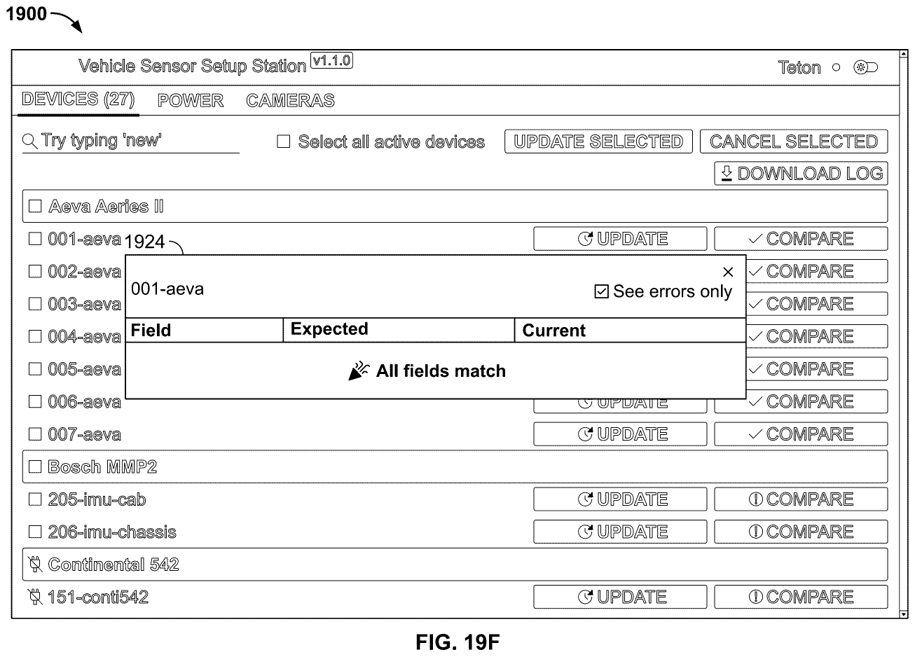

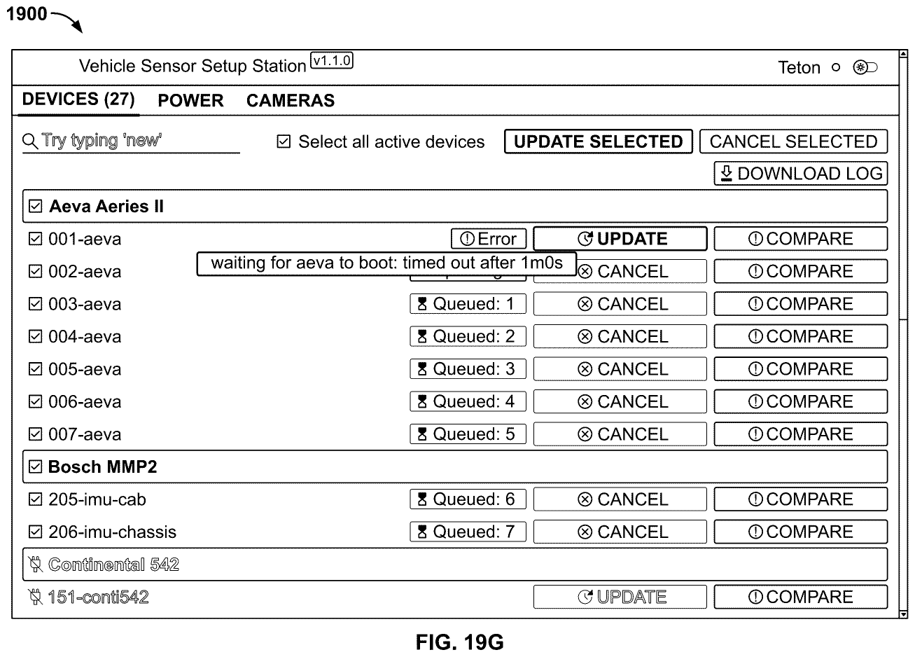

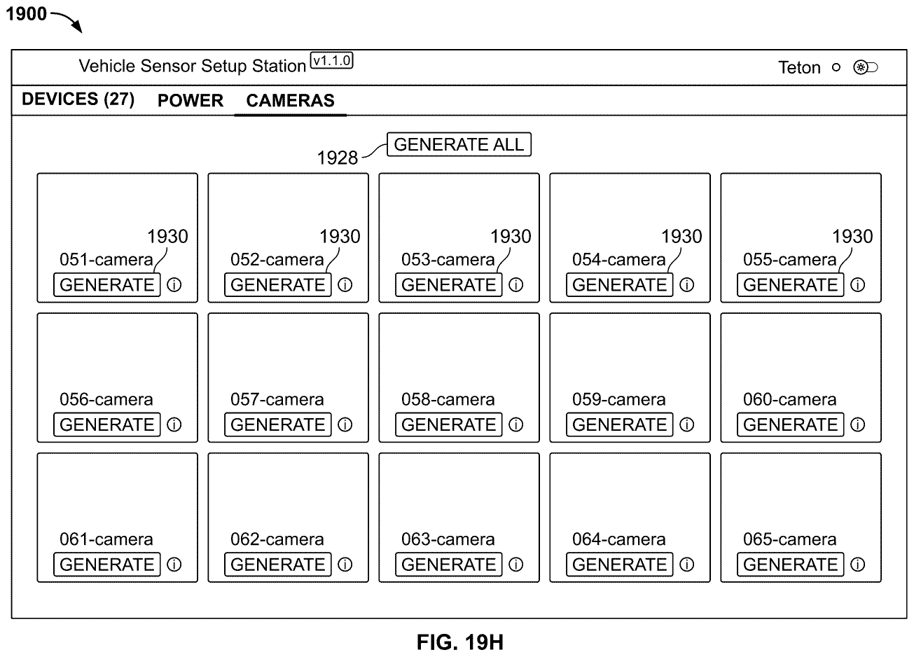

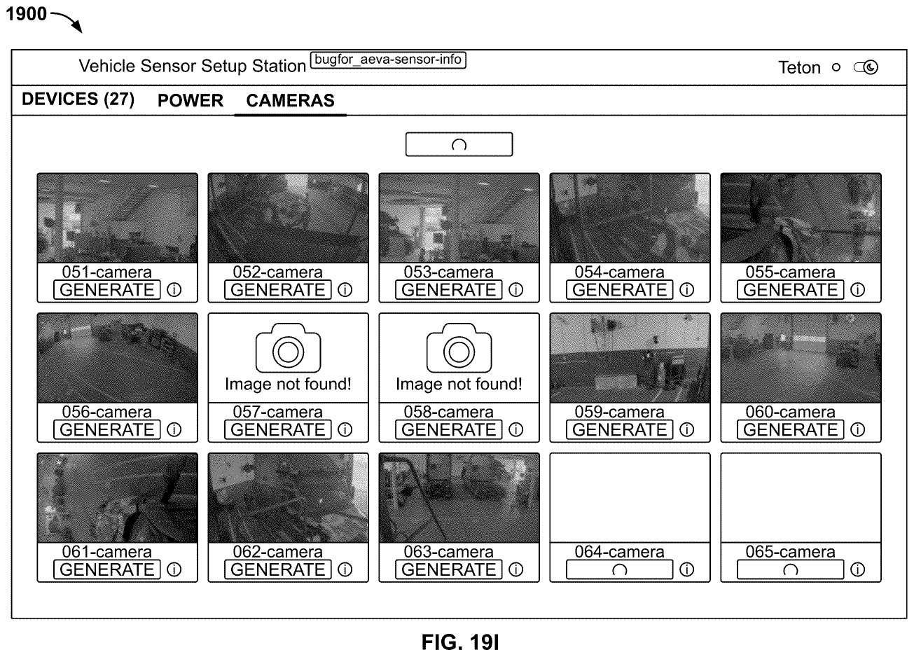

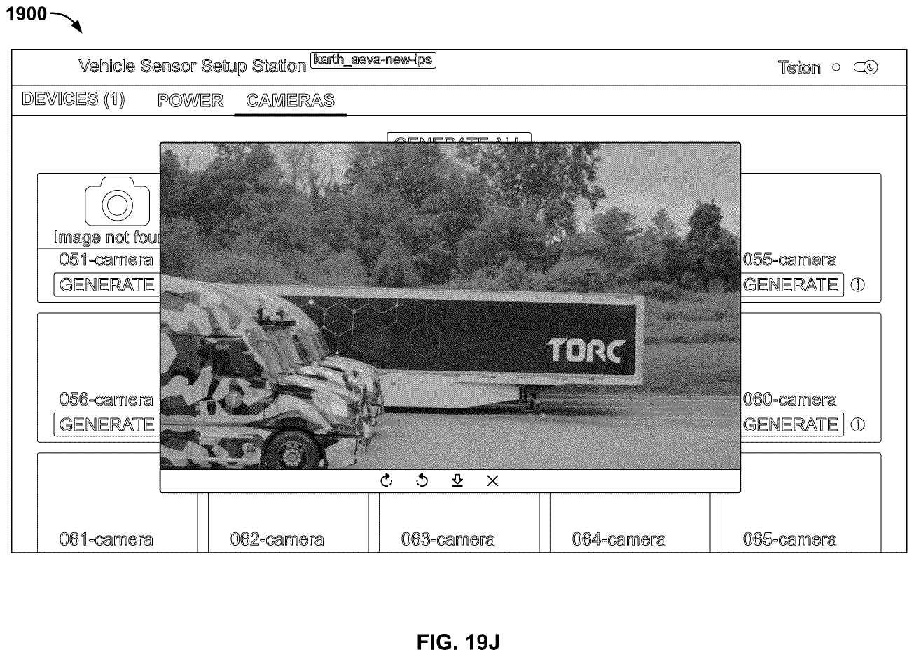

FIG. 19A-19I are screenshots of various instances of a UI 1900 for configuring sensors, according to an example embodiment of the current disclosure. In some implementations, the UI 1900 can be provided by a website or webpage accessible via an IP address associated with the VS3 device 404. The UI 1900 can include a first menu or tab 1902, e.g., named “DEVICES”, for configuring sensors 402 other than cameras 214, a second menu or tab 1904, e.g., named “POWER”, for debugging purposes, and a third menu or tab 1906, e.g., named “CAMERAS”, for configuring cameras 224.

FIG. 19A-19J depict instances of the UI 1900 for managing configuration of sensors other than the cameras 214, according to an example embodiment of the current disclosure. Upon clicking or interacting with the tab 1902, the UI 1900 can display a list of sensors, other than cameras 214, connected to the VS3 device 404. The sensor 151-conti542 in FIGS. 19A-19G is powered off and is not available for selection. The UI 1900 can include, for each sensor in the list, a corresponding checkbox for selecting the sensor to be configured. The UI 1900 can include another checkbox 1908 for selecting all sensors, other than the cameras 214, connected to the VS3 device 404. The UI 1900 can include an interactive item 1910 for triggering configuration of the selected sensors, an interactive item 1912 for cancelling selection of the sensors, and an interactive item 1914 for downloading configuration logs or a configuration log file.

The user 10 can select all sensors using checkbox 1908, or can select a subset of sensors using corresponding checkboxes associated with individual sensors. The user can then interact with, e.g., click or tap, the interactive item 1910 to trigger the configuration of the selected sensors. In response, the UI 1900 can display a window 1916, as depicted in FIG. 19B, asking the user 10 to confirm the configuration of the selected sensors. The window 1916 can display a list of the selected sensors to be configured, an identifier of the vehicle 100, and email address or some other identifier of the user. The window 1916 can include an interactive item 1918 to confirm the configuration of the selected sensors and an interactive item to cancel the configuration.

FIG. 19C depicts an instance of the UI 1900 illustrating real-time or near real-time progress of the configuration of the selected sensors. The UI 1900 can depict the order according to which the selected sensors are to be serially configured, and can display an indication of the sensor being configured at any time instance. FIG. 19D shows an instance of the UI 1900 depicting progress in validating the configured sensors. Once the selected sensors are configured, the UI 1900 can show results of comparisons of updated configuration settings with corresponding expected configuration settings, e.g., performed by the validation module 1428. The comparison results 1922 can be displayed by the UI 1900 in real-time or near real-time. The user 10 can select a sensor with validated configuration and in response the UI 1900 can display a window 1924 depicting the expected configuration settings and the current configuration settings of the sensor, as depicted in FIG. 19E. The window 1924 can include a checkbox 1926, which when selected by the user 10, the window 1924 can display only validation errors or mismatches between the expected configuration settings and the current configuration settings for the selected sensor, as depicted in FIG. 19F. FIG. 19G shows an instance of the UI 1900 depicting an error message associated with an error that occurred while updating or configuring a sensor 402.

Once the configuration of the selected sensors is completed, the user 10 can interact with visual interactive item 1914 to download configuration logs for configured sensors. In response, the user device 10 can download a configuration log file from the VS3 device 404. The user 10 can open the configuration log file to check current configuration settings for configured sensors.

FIG. 19H-19J show instances of the UI 1900 depicting configuration of the cameras 214, according to an example embodiment of the current disclosure. The user 10 can interact with, e.g., click or tap, the tab 1906, the UI 1900 can display a list of the cameras 214 connected to the VS3 device 404 as depicted in FIG. 19H. The UI 1900 can include an interactive item 1928 to trigger generating images (or video sequences) by all the cameras 214 connected to the VS3 device 404. The UI 1900 can include, for each camera 214, a corresponding interactive item 1930 to cause the camera 214 to generate an image or video sequence. The user 10 can use the interactive item 1928 to select all cameras 214 for generating images or video sequences, or can use the interactive items 1930 to select a subset of cameras 214 for generating respective images or video sequences.

FIG. 19I shows an instance of the UI 1900 depicting images generated by selected cameras 214. The images generated by the cameras 214 can be displayed in the UI 1900 in real-time or near real-time. For each camera 214, the UI 1900 can show a corresponding generated image as soon as the image is received from the camera 214. The UI 1900 can include, for each camera 214, a corresponding information icon, which when interacted with cause the serial number of the camera 214 to be displayed. The user 10 can select an image captured by corresponding camera 214 for viewing. In response, the UI 1900 can display the selected image, e.g., in original size, as depicted in FIG. 19J. The user 10 can check the quality of the image to make sure that the corresponding camera 214 is operating properly.

After completing all configurations, the local user 10a can disconnect the sensors 402 and power off the VS3 device 404. The user 10 can complete and submit the relevant configuration and inspection checklists for approval. For example, the remote computer system 406 can provide a vehicle commissioning portal. The user 10 can select a vehicle 100 through the vehicle commissioning portal to check a corresponding checklist associated with sensor configuration. The user can review and sign the checklist. The checklist is then submitted for approval. A quality engineer can approves the checklist, compile documentation for commissioning records, and upload the compiled documentation to document management system (DMS).

While FIG. 6-19J are described in relation to configuration of vehicle sensors, a person skilled in the art would appreciate that embodiments described herein can be applied to sensor configuration in other field applications. For example, the sensors to be configured can be sensors of a piece of equipment, sensors associated with an industrial site, sensors associated with a farm or sensors used in other types of applications. In general, the VS3 device 404 can be an edge configuration device, e.g., not necessarily specific to vehicle sensors.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for automatic configuration of vehicle sensors, the system comprising:
a plurality of connectors to connect to a plurality of sensors of a vehicle, each connector is configured to provide a power connection and a data connection to a sensor of the plurality of sensors; and
a computing device including one or more hardware processors, the computing device configured to:
identify each sensor, of the plurality of sensors, connected to a corresponding connector of the plurality of connectors;
receive, via a user interface (UI), information indicative of a selected subset of sensors of the plurality of sensors to be configured;
send a request for configuration settings of the subset of sensors to a remote computer system;
receive, from the remote computer system, the configuration settings responsive to the request; and
configure, using the configuration settings, the subset of sensors in a configuration session.

2. The system of claim 1, comprising:
one or more automotive Ethernet switches connected to the plurality of connectors and configured to transform automotive Ethernet data to standard Ethernet data.

3. The system of claim 1, wherein the plurality of connectors are connectable to the plurality of sensors via one or more bulkhead interface devices.

4. The system of claim 1, wherein the plurality of sensors includes a set of sensors mounted on a sensor bar structure.

5. The system of claim 1, wherein the computing device is configured to communicate with the plurality of sensors through an open systems interconnection (OSI) model layer lower than an application layer.

6. The system of claim 1, wherein the computing device is configured to:
send, to each sensor of the plurality of sensors, a request for a serial number of the sensor; and
receive, responsive to the request for the serial number, the serial number of the sensor.

7. The system of claim 1, wherein the computing device is configured to send to the UI information identifying the plurality of sensors connected to the plurality of connectors.

8. The system of claim 1, wherein the plurality of sensors includes one or more light detection and ranging (LiDAR) sensors, the configuration settings for each LiDAR sensor includes at least one of:
firmware update data;
an internet protocol (IP) address for the LiDAR sensor; or
one or more upload scan patterns.

9. The system of claim 1, wherein the plurality of sensors includes one or more radio detection and ranging (radar) sensors, the configuration settings for each radar sensor includes at least one of:
firmware update data; or
an IP address for the radar sensor.

10. The system of claim 1, wherein the plurality of sensors includes one or more cameras, the configuration settings for each camera includes visualization check data.

11. The system of claim 1, wherein the plurality of sensors includes one or more inertial measurement units (IMUs), and the configuration settings for each IMU includes functional check data.

12. The system of claim 1, wherein the computing device is configured to configure the subset of sensors concurrently.

13. The system of claim 1, wherein the computing device is configured to send, to the remote computer system, information indicative of progress of the configuration of subset of sensors, the information indicative of the progress of the configuration is provided for display on the UI.

14. The system of claim 1, wherein the computing device is configured to:
receive, from a sensor of subset of sensors, an indication of completed configuration of the sensor;
acquire, from the sensor, configuration settings recorded at the sensor;
compare the configuration settings recorded at the sensor to corresponding configuration settings received from the remote computer system; and
send an indication of a result of the comparison to the remote computer system for display in the UI.

15. The system of claim 1, wherein the computing device includes at least one of:
a wireless edge router configured to host a subscriber identity module (SIM) card for connecting to a wireless communications network; or
an antenna to communicate with satellites.

16. A method for automatic configuration of vehicle sensors, the method comprising:
identifying each sensor of a plurality of sensors coupled to an edge device, the edge device including:
a plurality of connectors each of which is configured to provide a power connection and a data connection to a sensor of the plurality of sensor;
a computing device including one or more hardware processors; and
receiving, via a user interface (UI), an indication of at least a selected subset of sensors of the plurality of sensors to be configured;
sending a request for configuration data of the subset of sensors to a remote computer system;
receiving, from the remote computer system, the configuration data responsive to the request; and
configuring, using the configuration data, the subset of sensors in a single configuration session.

17. The method of claim 16, comprising:
sending, to each sensor of the plurality of sensors, a request for a serial number of the sensor; and
receiving, responsive to the request for the serial number, the serial number of the sensor.

18. The method of claim 16, comprises configuring the subset sensors concurrently.

19. The method of claim 16, comprises sending, to the remote computer system, information indicative of progress of the configuration of the subset of sensors, the information indicative of the progress of the configuration is provided for display on the UI.

20. The method of claim 16, comprising:
receiving, from a sensor of the subset of sensors, an indication of completed configuration of the sensor;
acquiring, from the sensor, configuration settings of the sensor;
comparing the configuration settings of the sensor to corresponding configuration settings obtained from the remote computer system; and
sending an indication of a result of the comparison to remote computer system for display in the UI.
